(19) United States
(12) Patent Application Publication
(10) Pub. No.: US 2005/0027858 A1
(43) Pub. Date: Feb. 3, 2005

(54) System and method for measuring and monitoring performance in a computer network

(75) Inventors: Poul Henrik Sloth, Gloustrup (DK); Michael Nielsen, Valby (DK); Henrik Wendt, Frederiksberg (DK); Morten Knud Nielsen, Narrum (DK)

Correspondence Address: FOLEY AND LARDNER;SUITE 500, 3000 K STREET NW, WASHINGTON, DC, 20007, US

(73) Assignee: PremiTech A/S

(21) Appl. No.: 10/889,230

(22) Filed: Jul. 13, 2004

Related U.S. Application Data
(60) Provisional application No. 60/487,225, filed on Jul. 16, 2003.

(51) Int. Cl. G06F 15/173

(52) U.S. Cl. 709/224

(57) ABSTRACT

A method and a computer program product for measuring and monitoring performance in a computer network environment that includes multiple clients and one or more servers providing one or more services is disclosed. The method includes monitoring the performance at each client based on true requests send to the servers over a network connection. The performance at each client is collected at a performance monitor database, where the collected performance data can be extracted to yield the performance of e.g. specific servers or services towards a specific client or a group of clients or the performance of a connection between a server and a client. The system performance is thereby measured at the clients where the system performance is actually utilized. The present invention thereby provides a more realistic scenario of the actual system performance than prior art systems based on monitoring server performance at the servers or through simulated clients.

### CROSS-REFERENCE TO RELATED PATENT APPLICATIONS

This application claims priority to provisional U.S. Application 60/487,225, filed Jul. 16, 2003, incorporated herein by reference in its entirety.

### FIELD OF THE INVENTION

The present invention relates generally to a system and method for measuring and monitoring performance in a computer network environment. More in particularly the system measure in real-time, system performance at end-user level.

### BACKGROUND OF THE INVENTION

Today there exist many different kinds of IT tools that IT managers and system administrators can use for optimisation of computer network environments. In general IT managers have three main objectives: to optimise present and future IT investment, to keep business critical applications and services at best possible shape and to focus on IT productivity and security where revenue is generated. In order to fulfil these short and long-term objectives they need access to a constantly updated overview of all components and applications involved and valid data about IT-systems performance at all levels.

Furthermore, since as well external and internal networks are becoming increasingly used by all parts of most companies, that is both in production, administration and financial departments, the demand for well functioning IT devices and components become equally increasingly important, since a decrease in the productivity due to long waiting times for their business critical applications and services may result from poorly administered IT systems.

Not only the traditional industry experience these problems. The deregulation and globalisation of financial markets have opened up a new area for companies where the business is mainly build up on information transactions. For these companies a well, functioning computer network is of outmost importance in order to support their front end users and customers.

Today this is done at many companies by monitoring performance of single components within the IT system. This is known as Functional Monitoring characterised by focusing on a company's IT-technical means.

Functional monitoring is mostly performed by using a large system management package, and tools like these produce important data indicating the status of single components. However, despite the widely use of these tools, poor IT systems performance still is a common problem in many companies.

Large system management packages provide only little data about the quality of the IT services delivered to the end users. But if the service level at that point is not satisfying, it is crucial to obtain information about what part of the system is lagging behind on performance, especially since many systems extend physically over many companies which may be geographically separated, and thus affect many technicians with sharply defined roles and budgets.

### DESCRIPTION OF THE INVENTION

It is an object of the present invention to provide a system for measuring the true performance of a system of interconnected electronic devices.

It is a further object of the present invention to provide a system for measuring response time at the end-user level.

It is a still further object of the present invention to provide efficient error detection by an administrator.

The above and other objects are fulfilled by a method for measuring and monitoring performance in a computer network environment according to the present invention, the computer network environment comprising multiple clients and one or more servers providing one or more services, the method comprises: monitoring at each client at least a first performance parameter representing the interaction between the client and a server for true requests sent to a server, this performance parameter comprising information about which type of service the request was related to and to which server it was sent, providing a performance monitor database connected to the network, collecting data representing the monitored performance parameters from each client at the performance monitor database, and combining performance parameters for requests sent to a specific server and/or requests related to a specific service type and/or requests sent from a specific group of clients, thereby extracting, from the data monitored at the clients, performance parameters for one or more servers and/or one or more services and/or a connection between a server and a client, whereby the database contains data representative of the at least first performance parameter over time. Preferably, the monitored performance parameters are collected repetitively, such as for each true request or for true requests fulfilling a predetermined parameter.

According to a second aspect of the present invention the above and other objects are fulfilled by a method for measuring and monitoring performance in a computer network environment according to the present invention, wherein the computer network environment comprises at least a first group and at least a second group, each group comprising at least one electronic device, the method comprises:
collecting, during a predetermined period of time, data representative of at least a first performance parameter, said first performance parameter being related to the performance of the at least second group in response to true requests from the at least first group, storing the collected data in a database comprised in the computer network environment, and repeating the steps of collecting and storing,
whereby the database contains data representative of the at least first performance parameter over time.

According to a third aspect of the invention, a system for measuring and monitoring performance in a computer network environment, the computer network environment comprising multiple clients and one or more servers providing one or more services, the system further comprising:
an agent for collecting, during a predetermined period of time, data representative of at least a first performance parameter, said first performance parameter being related to the performance of the one or more servers in response to true requests from at least one client, and a database for storing the collected data, wherein the agent repetitively collects data and provide the data to the database, whereby the database contains data representative of the at least first performance parameter over time.

According to a fourth aspect of the invention, a system for measuring and monitoring performance in a computer network environment is provided, wherein the computer network environment comprises at least a first group and at least a second group, each group comprising at least one electronic device, the system further comprising:
an agent for collecting, during a predetermined period of time, data representative of at least a first performance parameter, said first performance parameter being related to the performance of the second group in response to true requests from the first group,
a database for storing the collected data, wherein the agent repetitively collects data and provide the data to the database, whereby the database contains data representative of the at least first performance parameter over time.

It is an advantage of the method and the system according to the first, second, third and fourth aspects of the present invention as described above, that a solution of the problem of measuring response time at the end-user level is provided. The system and the method as described above may provide the data needed to deliver an active and proactive problem solving effort and in addition lead to better utilisation of technical IT human resources, decreased cost of IT support and maintenance and increased IT system uptime.

When measuring application response time at end-user level and response time from server to end-user, performed on a real time basis, IT management will gain exact knowledge about system performance at all times. Combined with exact mapping of hardware- and software profile on all end-user PCs, IT managers will possess the overview and the details to fulfil both their short term and long term objectives.

The computer network environment may be any network environment having any kind of infrastructure. It may be wired network or a wireless network or it may furthermore be partly a wireless network and partly a wired network.

The electronic device comprised in the first group may form a part of a front-end system.

The electronic device comprised in the second group may form a part of a back-end system.

The electronic device in the network environment may comprise a network device. The network device may comprise client computers, server computers, printers and/or scanners, etc., thus the network device may be selected from a set consisting of client computers, server computers, printers and scanners.

Preferably, the first group comprises client computers and the second group comprises server computers.

Furthermore, the first group and the second group in the computer network environment may further comprise a second electronic device. The second electronic device may comprise a network device, being selected from a set consisting of client computers, server computers, printers and scanners.

The first performance parameter may represent a response time of the second group upon a request from the first group.

When monitoring performance in a computer network environment according to the present invention, it may further comprise monitoring at each client a client performance parameter of the operational system of the client.

Furthermore the performance parameter monitored at each client may be related to the performance of the server in response to true requests from the client.

In the present context the term “true request” is to be interpreted as a request send from an electronic device in the first group during normal operation to an electronic device in the second group. The request is thus sent from a client upon user interaction with an application program. It is thus an advantage of using true requests that the measured performance is not measured on the basis of artificial requests generated by the performance system or by any other program adapted to generate test request, but on the basis of actual requests. Hence true request preferably relates to service request triggered by a user interaction.

Typically, two types of information are exchanged between the server and client:
i) application data and
ii) handshakes.

Whenever a connection is established or terminated a number of handshakes are exchanged between the server and client. These handshakes are sent in separate packets without application data. During the lifetime of a connection, handshakes are send either as separate packages or as part of packets that carry application data. In the preferred embodiment, packets that contain application data are considered when the performance system measures response times.

When a client sends a request to a server, it sends one or more packets to the server. The server then processes the request and sends one or more packets back to the client.

The response time is the time interval starting when the request, to the second group, has been sent from the first group until the response from the second group arrives at the first group.

The collection of data in the network environment may be performed by at least one agent comprised in the first group. The collection of data may be performed passively by the agent. The agent(s) may be distributed to each electronic device in the first group by a software distribution tool. The agents may be automatically installed and they may automatically begin collection and reporting of data substantially immediately after installation to the central performance system server, which may at least partly be dedicated to collect, process and display data reported by the agents.

The at least first performance parameter measured in the method may be selected from the set of:
1. CPU usage
2. memory usage, such as free physical memory or such as virtual memory, or such as free paging file,
3. Process name
4. Process Id for a given process
5. Thread count for a given process
6. CPU usage for a given process
7. Handle count for a given process
8. Memory usage for a given process
9. Client MAC address
10.Client IP address
11.Client TCP/IP port number
12.Server/gateway Mac address
13.Server IP address
14.Server TCP/IP port number
15.Response time histogram
16.Number of transferred bytes
17.Number of made connections
18.Number of transmissions
19.Number of packet trains sent/received

The data in the database may be organised in data sets so that each set of data represents at least one specific group of electronic devices, wherein a specific group corresponds to at least one of the first group. Thus, a specific group may comprise all the printers in the network environment or all the client computers in a specific geographical location, or the client computers of a special employee group.

The data in the database may furthermore be organised in data sets so that each set of data represents a specific group of electronic devices, wherein the specific group corresponds to one of the second group(s). Thus, a specific group may comprise all e-mail servers, Internet servers, proxy servers, etc.

The data representing the first performance parameter may be represented by consolidated data being the data accumulated into one or more predetermined performance parameter intervals and stored in the database. Hereby, a system administrator may easily see if e.g. only a single response time causes a high mean response time for a specific group, etc.

The data representing the first performance parameter is represented by consolidated data being the data accumulated into one or more predetermined time intervals and stored in the database. Hereby, it is possible for a system administrator to trace e.g. specific times traditionally having a high load. The network environment may thus be designed e.g. to perform according to certain standards in high load intervals.

The consolidated data may represent the performance of an electronic device in the second group, in relation to at least one electronic device in the first group. Thus, the combination of a measured performance parameter obtained from a number of devices in the first group may be used to derive a characteristic parameter, for at least one single device in the second group. By doing this it is possible to see the performance of a server in relation to, for example a group of client computers.

The computer network environment may comprise at least one administrator device, and the administrator device may for example be provided in the front-end system of the computer network environment. The back-end system may comprise the database.

The database may comprise a relational database.

The data may be presented in an administrator display and the display may comprise reports and may further at least partly be protected by a password.

The administrator display may comprise a graphical interface, which for example may be accessible through any electronic device having a display. The administrator display may furthermore be accessible through a standard Internet web browser, a telecommunication network, a cellular network, through any wireless means of communication, such as radio waves, electromagnetic radiation, such as infra red radiation, etc.

According to a fifth aspect of the invention, a method of performing error detection in a computer network environment is provided. The method comprises using data representative of at least a first performance parameter, the data being provided to a database using a method as described above, to provide information of the at least first performance parameter to an administrator of the computer network environment for error detection/tracing.

The error detection is preferably performed on component level wherein the component may comprise CPU, RAM, hard disks, drivers, network devices, storage controllers and/or storage devices, thus the component may be selected from a set consisting of CPU, RAM, hard disks, drivers, network devices, storage controllers and storage devices.

In a still further aspect of the invention a computer program product for measuring and monitoring performance in a computer network environment, the computer network environment comprising multiple clients and one or more servers providing one or more services, the computer program product comprising means for:
monitoring at each client at least a first performance parameter for the interaction between the client and a server for each true request to a server, this performance parameter comprising information of which type of service the request was related to and to which server it was sent, providing a performance monitor database connected to the network, repetitively collecting data representing the monitored performance parameters from each client at the performance monitor database, and combining performance parameters for requests to a specific server and/or requests related to a specific service type and/or requests from a specific group of clients,
whereby the database contains data representative of the at least first performance parameter over time.

In a still further aspect of the invention a computer program product for measuring and monitoring performance in a computer network environment is provided. The computer network environment comprises at least a first group and at least a second group, each group comprises at least one electronic device, the method comprising:
collecting, during a predetermined period of time, data representative of at least a first performance parameter, said first performance parameter being related to a true performance of the second group in response to true requests from the first group,
storing the collected data in a database comprised in the computer network environment,
repeating the steps of collecting and storing,
whereby the database contains data representative of the at least first performance parameter over time.

The computer program product may further be loaded onto a computer-readable data carrier and/or the computer program product may be available for download via the Internet or any other media for allowing data transfer.

### BRIEF DESCRIPTION OF THE DRAWINGS

FIG. 1a shows a client/server diagram.

FIG. 1 illustrates the basic design of the system.

FIG. 2 shows a response time graph, with alarm and baseline markers.

FIG. 3 shows the time view setting interface.

FIG. 4 shows the tag view graph interface.

FIG. 5 shows the Server/Port setting interface.

FIG. 6 shows the Server/Group setting interface.

FIG. 7 shows a calendar used for selecting dates.

FIG. 8 shows the interface for selecting custom interval for the bar chart calculation.

FIG. 9 shows the alarm display.

FIG. 10 shows the scatter plot setting interface.

FIG. 11 shows the histogram bar chart interface.

FIG. 12 shows the average distribution interface.

FIG. 13 shows the result table after an agent search.

FIG. 14 shows an agent search interface.

FIG. 15 shows the agent traffic interface.

FIG. 16 shows the agent usage graph interface.

FIG. 17 shows a group table for an agent.

FIG. 18 illustrates an interface for creating new agent groups, and a table showing agent group definitions.

FIG. 19 illustrates an interface for creating new server groups and a table showing server group definitions.

FIG. 20 illustrates an interface for creating new port groups and a table showing port group definitions.

FIG. 21 illustrates an interface for creating new groups and a table showing group definitions.

FIG. 22 shows an interface for process reports.

FIG. 23 shows an interface for network reports.

FIG. 24 shows a user interface, these parameters affect how the agent interacts with the operating system's graphical user interface.

FIG. 25 shows filters that are shared by all agent configuration groups.

FIG. 26 illustrates how agents can be selected from a search when the user uses the agent administration interface.

FIG. 27 shows a user interface for adding and removing agents from a group.

FIG. 28 shows a monitored server list and a user interface for server management.

FIG. 29 shows a list for discovered servers.

FIG. 30 shows a list of monitored ports.

FIG. 31 shows a list of discovered ports.

FIG. 32 shows an interface for creating a new port.

FIG. 33 shows an interface for creating a bar chart.

FIG. 34 shows an interface for creating a pie chart.

FIG. 35 shows an interface for creating a baseline.

FIG. 36 illustrates an example of a response time graph with a base line and alarm line.

FIG. 37 shows an interface for creating or editing filters.

FIG. 38 shows the window for editing a filter.

FIG. 39 shows a view of the database status table.

FIG. 40 shows the log in window for users.

FIG. 41 shows an interface for creating a new user.

FIG. 42 shows the login window for the administrator.

FIG. 43 shows a table of existing reports.

FIG. 44 shows the window for editing a report.

FIG. 45 shows the Add to customer report link.

FIG. 46 shows an overview of the computer system.

FIG. 47 shows response time before a system upgrade. End-users have temporarily long response times.

FIG. 48 shows response time after a system upgrade.

FIG. 49 shows an example of a bottleneck. This is how it looks when the server runs out of resources and the response time gradually increases. The increase of response times could not be detected at the server because no functional error occurred.

FIG. 50 shows the response time from a server. This graph may be used to spot trends in the response time.

FIG. 51 shows response time for an application hosted in Denmark. This chart is a performance guard example of an office (A) in another country. The problem turned out to be the available bandwidth in the office (A). A single user could occupy most of the available bandwidth with a download from the Internet.

FIG. 52 shows the amount of downloaded data by a user at office (A). This user downloaded more than 100 MB in 35 minutes.

FIG. 53 shows a graph for comparing different locations. Different local offices access the same server. The server is for example situated in Denmark. Graphs like this can be used as a mean to find out how the different parts of the network perform. Each column represents the average response time that each local office experience from the server in Denmark.

### DETAILED DESCRIPTION OF THE PREFERRED EMBODIMENTS

The Performance system is a software product for monitoring IT system performance delivered to the end users and client PC performance.

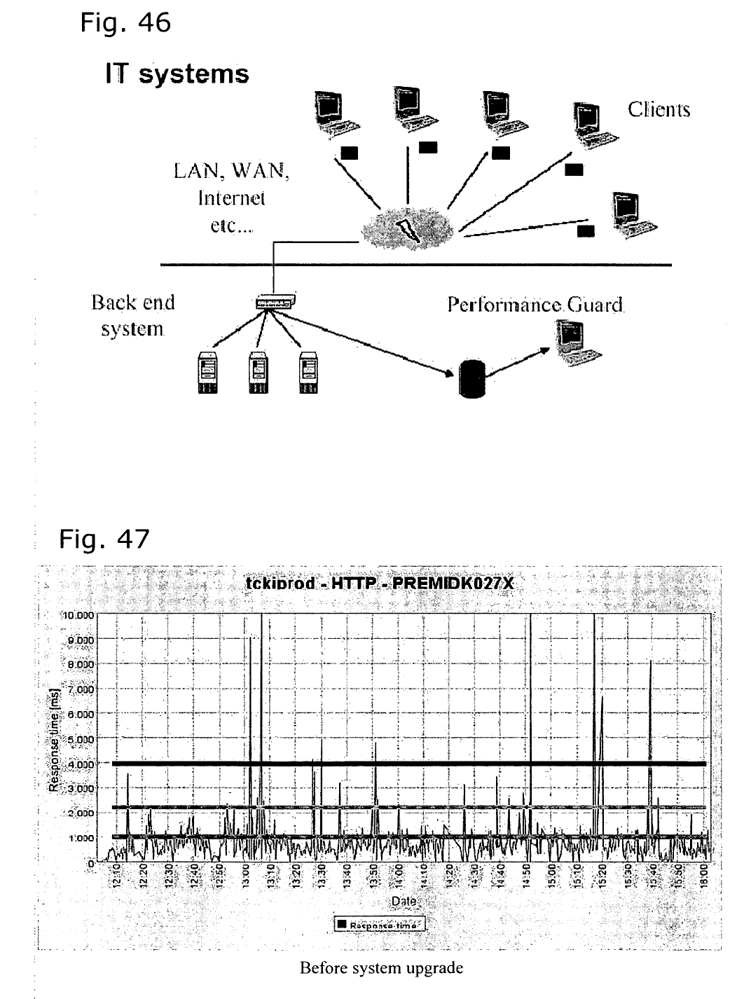

By installing a small agent on each monitored PC, performance data is collected and delivered to a central server where performance data is consolidated in a database. The performance data are available to administrators through a web interface. An example of an IT system is illustrated in FIG. 46.

Concepts

Response Time

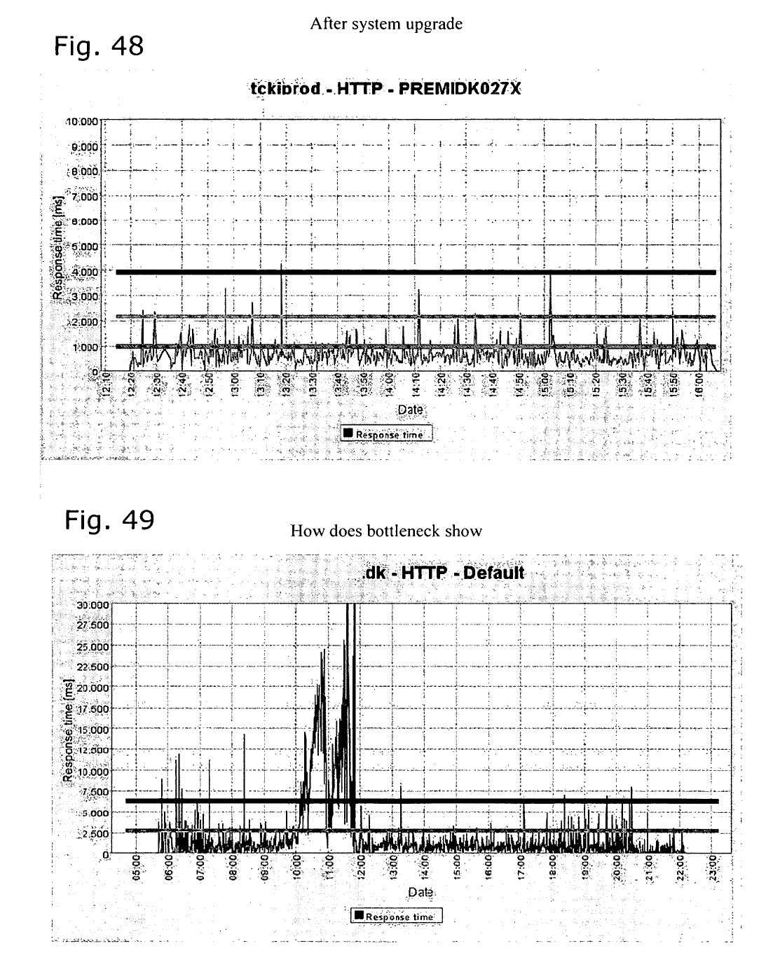

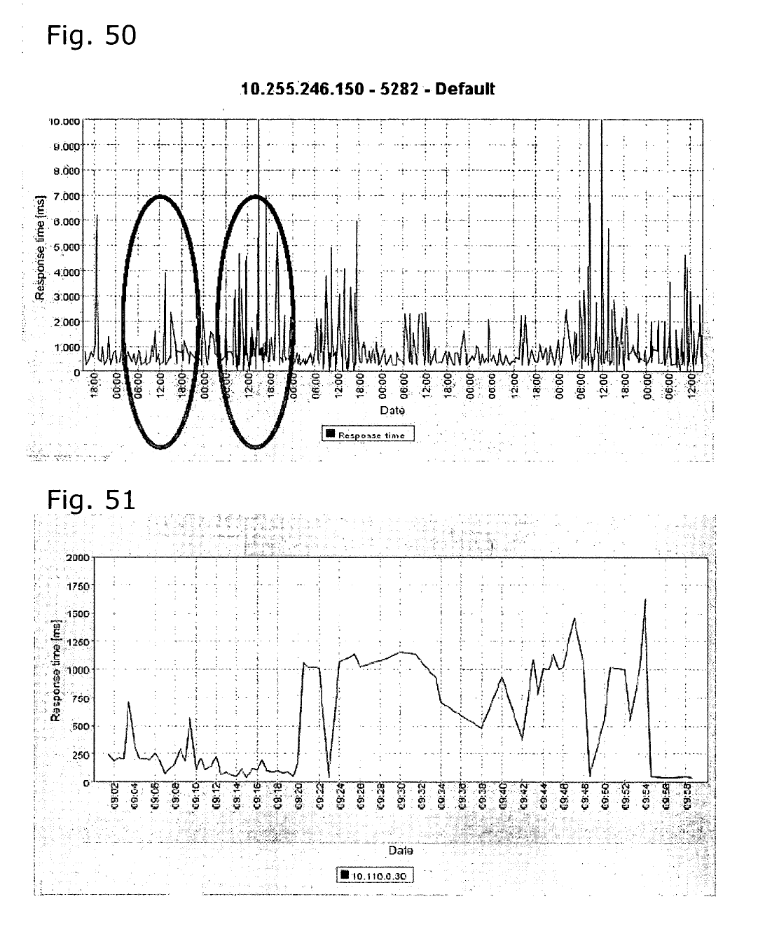

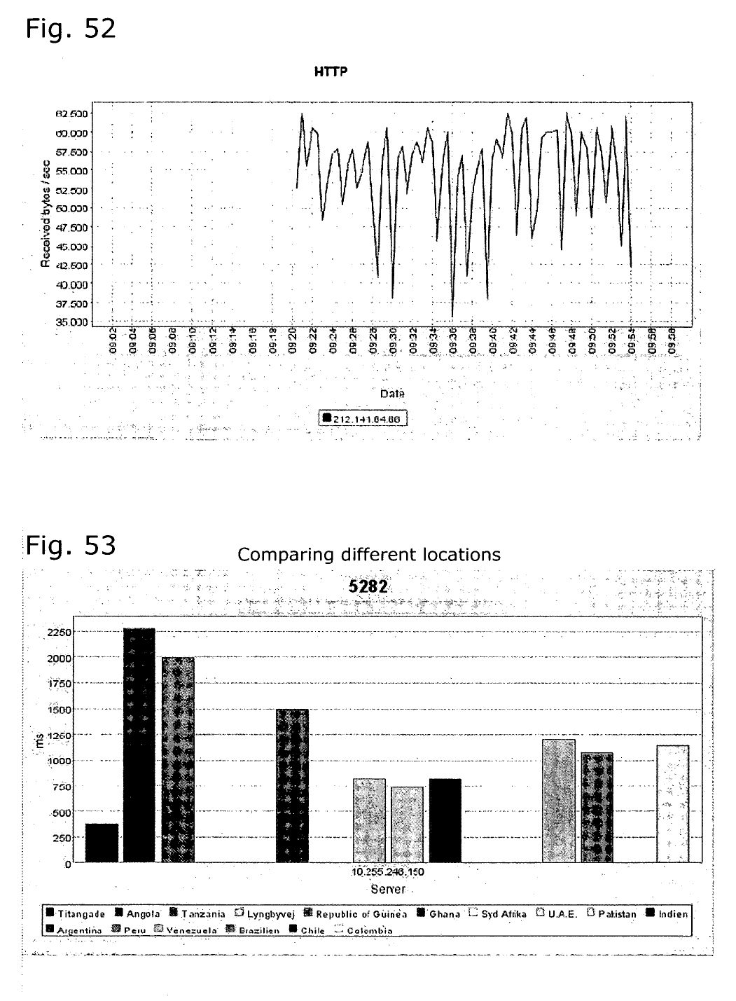

The performance system measures response time at the network level, and to be more specific at the TCP/IP level. The graph in FIG. 49 illustrates how the response time gradually increases when a server runs out of resources. and. The increase in response time shown in FIG. 49 could not be detected at the server because no functional error occurred. The graph in FIG. 50 can be used to spot trends in the response time. FIG. 47 shows response time before system upgrade, and FIG. 48 shows response time after system upgrade. The graphs in FIGS. 51 and 52 show a situation where the bandwidth is sufficient for normal operation but where a download from the Internet by one end-user increases the response times for other end-users. This increase in response time occurred without any indications of problems at the servers.

In FIG. 53, a comparison between different locations is shown. Different local offices access the same server. Such graphs can be used to analyse how the different parts of the network perform, providing that the type of data exchanged between the server and the clients are the same across all locations. Each column represents the average response time that each local office experience from this server. The performance guard system measures the total response time. A number of factors contribute to the total response time, these factors are:
1. response time from the server itself
2. Latency caused by physical distance between server and clients
3. Delay in the network (LAN-server side, WAN, LAN- client side)
4. Client speed and the amount of free resources on the client

The graph in FIG. 53 show the real life response times that the end-users have experienced around the globe in real time and they form baselines for system performance. Every time a server is patched, the network is reconfigured or a new system is put online, the effect on all end-users can be seen instantly. And equally important: if a problem occurs, the technical staff can use these graphs to identify the underlying cause of this particular problem.

TCP/IP

TCP/IP is the most commonly used protocol today, and dominates the internet completely. Services such as web (HTTP) and file transfer (FTP) uses the TCP/IP protocol.

The following is an introduction to the TCP/IP and is not meant to be a in-depth technical description. For details about TCP/IP, see for example www.faqs.org/rfcs/ where the various RFC's that define the Internet protocols are described, or the book TCP/IP Illustrated by W. Richard Stevens (Addison-Wesley 1994).

TCP/IP is a connection-oriented protocol; this means that a connection is kept between two parties for a period of time. The two parties that communicate are usually referred to as client and server. Communication between the client and server takes place in the form of packets.

Each packet holds a number of bytes (data).

A number of packets flowing in one direction without packages flowing in the opposite direction are called a train.

Two types of information are exchanged between the server and client:
i) application data and
ii) handshakes

Whenever a connection is established or terminated a number of handshakes are exchanged between the server and the client. These handshakes are sent in separate packets without application data. During the lifetime of a connection, handshakes are sent either as separate packages or as part of packets that carry application data. In a preferred embodiment, packets that contain application data are considered when the performance system measures response times. This is illustrated in figure la.

When a client sends a request to a server, it sends one or more packets to the server. The server then processes the request and sends one or more packets back to the client.

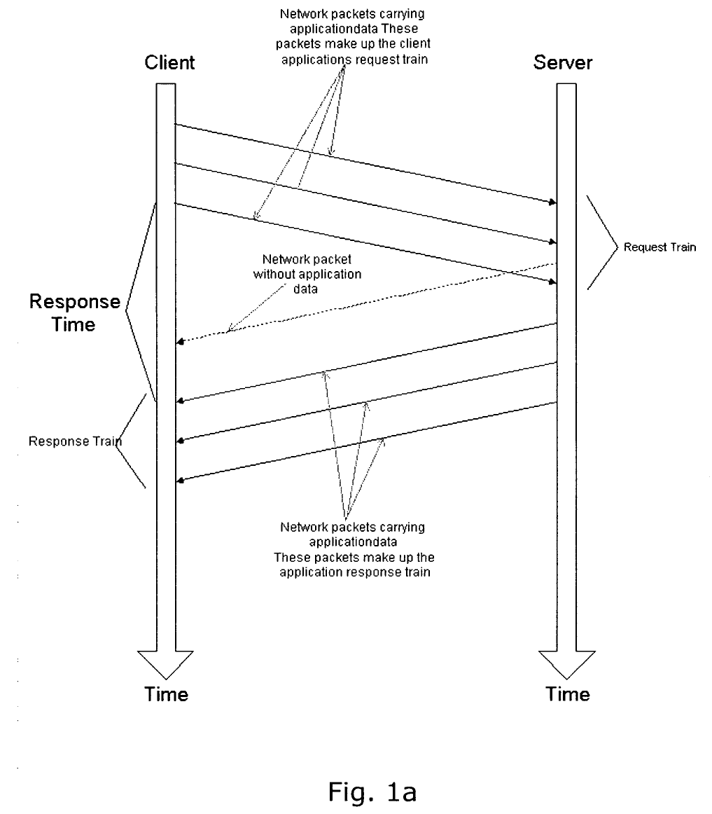

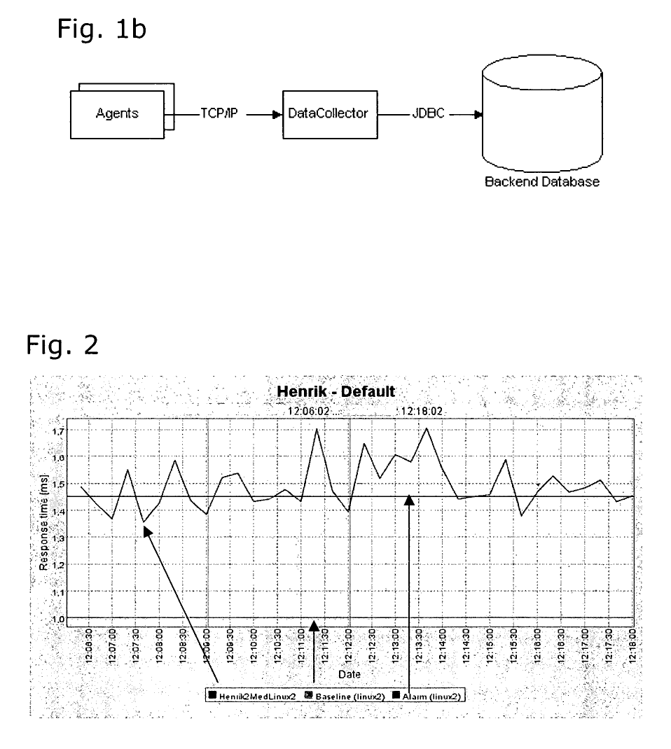

The performance system response time is defined as the time elapsed between the last request-packet has been sent until the first reply-packet is received from the server. This is illustrated in FIG. 1a.

Aggregation of Response Times

An agent aggregates response time measurements based on the server and the TCP port on which server the client communicates with. For example, response times for all communication with a specific web server within a single report period, the following may be reported to the back end:
accumulated response time
number of connections
number of trains send and received
number of bytes send and received

The response time for the combination of <agent, server, service>is calculated by the back-end as the accumulated response time divided by the number of received trains.

In order to display response times from measurements taken on multiple clients, it is necessary to aggregate the data further. In this case the response time concerning a group of agents and a specific <server, service>is calculated as the sum of accumulated response times divided by the sum of received trains for all agents in the group.

Local Performance Metrics

The agent preferably collects the following local performance metrics regarding the machine it is installed on:

| | |
|---|---|
| CPU Usage | Percentage of CPU time not |
| | spend running idle |
| Free physical | Amount of physical memory |
| memory | available for allocation |
| Free paging | Amount of paging file space |
| file | available for allocation |
| Virtual | Amount of virtual memory |
| memory | available for allocation |

Values for these metrics are sampled at regular intervals. The sampling interval is controlled by the parameter ProcessStatInterval.

For each of the above, an average and an extreme value is reported. The average value is calculated as the mean of the sampled values.

The extreme values (maximum or minimum) are the extremes of the samples.

Process Performance Metrics

The agent preferably collects the following local performance metrics regarding the tasks that run on machine that it is installed on:

| | |
|---|---|
| CPU Usage | Percentage of available CPU time |
| | used for the particular process |
| Memory | Number of bytes that this |
| usage | process has allocated that |
| | cannot be shared with other |
| | processes |
| Thread Count | Number of operating system |
| | threads used by the process |
| Handle Count | Number of operating system |
| | (Windows) handles used by the |
| | process |

Values for these metrics are sampled at regular intervals. The sampling interval is controlled by the parameter ProcessStatInterval.

For each of the above an average and a maximum value is reported. The average value is calculated as the mean of the sampled values.

The maximum values are the largest of the samples.

Data Collection

Performance system collects data using Performance system agents on individual machines running Windows. Usually these machines are end-user PC's. The agents collect response time and other performance metrics on these machines. The data is assembled by the agent to reports. At predefined time intervals a collection of reports are send to the Performance system back-end.

At the Performance system back-end the data from the agents is handled by a DataCollector. This collector unpacks the reports and inserts the data in the

Performance system database. The basic design of the system is illustrated in FIG. 1b.

Communication between the agents and the back end is preferably done using TCP/IP. The data collector listens on a single TCP port (default is 4001) and the agents contacts the back end. In a preferred embodiment the back end preferably never contacts an agent, and the agents do not listen on any ports. If there are firewalls between the agents and the data collector these should be set up to forward requests to the data collectors TCP port to the data collector. The agents and the data collector communicate using a proprietary protocol.

The data collector and the back end database are connected using JDBC. When the back end database is an Oracle database the JDBC connection may be implemented as an SQLNet connection.

Timing Considerations

The agent may collect performance data in reports. A single report describes the performance for an interval of time e.g. 20 seconds.

With predefined time intervals the agent sends reports to the back end, this is typically done every few minutes.
Example: If reports each cover 20 seconds and reports are send to the back end every 3 minutes, 9 reports are send to the back end each time the agent connects to the back end.

In order to collect the local performance metrics (CPU Usage, memory usage etc.) the values are sampled at regular intervals, typically 1 or 2 seconds.
Example: If the local performance metrics are sampled every second, and reports cover 20 seconds, the average value for CPU usage is the average of 20 measurements, and the maximum value for CPU usage is the highest among the 20 sampled values.
   Configuring Agents

In the preferred embodiment the first step to be taken is to define which performance data the Performance system user want the agents to report.

A full description of the agent configuration settings and how to change them is found here.

When the Performance system user deploy an agent it may immediately start contacting the Performance system back end to receive its configuration. When the configuration is received the agent will start collecting and sending statistics preferably immediately. If the Performance system user deploy a huge number of agents the Performance system user might flood the network with unnecessary data reports because the Performance system user have chosen a bad agent configuration.

Choosing a Reasonable Report Interval

A short interval means high-resolution data but requires high bandwidth. A long interval means low-bandwidth requirements but low resolution data. A report interval of 20 seconds means that the Performance system user receive 3 reports pr. minute from every agent. That is 180,000 reports pr. hour. with 1000 agents.

Depending on the agent filters this means that between 60 and 100 Mbyte is sent to the Performance system Backend every hour. A normal setting is 30-120 seconds. Preferably it should not be set to lower than 10 seconds.

Filtering Data on the Agent

By filtering data at the agent level the Performance system user save bandwidth on the network and CPU and memory resources on both the client PC running the Performance system Agent and the Performance system Back-end server itself.

The Performance system user need to consider these filters before deploying a huge number of agents:
Limit the number of client processes reported. Windows NT/2000/XP has lots of idle processes running of no interest. Therefore the Performance system user may set a limit on the number of processes monitored by limiting the list to the top 10 CPU consumers or top 10 memory consumers.
Limit the reported agent network traffic. Reports of network traffic should be limited as much as possible by applying a network package filter to the Performance system Agent. I.e. the Performance system user might be interested in reporting network traffic from servers in the local TCP/IP network 192.168.101.0/24 and not any servers on the Internet. Then the Performance system user could enter the following Berkeley Package Filter “network 192.168.101.0/24” which limits traffic reports to servers on the 192.168.101.0/24 network.
   Deploying Agents

Agents can be deployed manually or through a software distribution system.

Installation

The installation may require only one file “AgentSetup.exe”.

The agent may be installed by executing the command
AgentSetup.exe-a “ip=<server_ip>port=<port_no>ra_install=<Y|N>ra_pwd=<password>group=<group_hint>agent₁₃id=<agent_id>”

Command line parameters

The agent installation program accepts these command line parameters

| Name | Description | Default value |
|---|---|---|
| ip=<server_ip> | The IP-address or | performanceguard |
| | hostname of the | |
| | Performance system | |
| | backend server | |
| port=<port_no> | The TCP port number | 4001 |
| | on which the | |
| | Performance system | |
| | backend server is | |
| | listening | |
| ra_install=<Y\|N> | Should the Remote | N (No) |
| | Administration utility be | |
| | installed together with | |
| | the agent, valid values | |
| | are Y for Yes and N for | |
| | No. | |
| ra_pwd=<password> | Remote Administration | ra_pguard. |
| | password | |
| group=<group_hint> | The agent group to | Default |
| | place the agent in at | |
| | first connection | |
| agent_id=<agent_id> | The agent identifier, | 0 |
| | this value should only | |
| | be changed by an | |
| | experienced | |
| | Performance system | |
| | administrator, using | |
| | this parameter without | |
| | a clear understandings | |
| | of the implications may | |
| | corrupt the agent | |
| | groups. | |

The agent_id parameter is most often used when reinstalling the entire Performance system, backend server as well as all agents, in this case set agent_id=0—this will force the agent to retrieve a new id from the backend Performance system server.

Preferably agents should have different agent_id (if agent_id>0).

The parameters may get their values from these locations in this order.
1. Command line values.
2. Registry values from previous agent installations. (applies to ip, port and agent_id parameters).
3. Default values.

Registration

Agents can be deployed without the Performance system Backend server being up and running. When the server is started the agents will register themselves automatically preferably within a few minutes.

If the Performance system user have a Performance system Display running the Performance system user may check that the agents are registering online by using the client search facility.

It may be prefered to install only a few hundred clients at a time to check that they are all registered.

Adding Servers

In the preferred embodiment, before the Performance system user can see any network traffic graphs, the Performance system user may need to specify which servers to monitor in the displays.

This is just for convenience as the number of reported servers might be so huge that it is impossible to handle in the graphs section of the display. So the Performance system user need to specify and single out each server for which the Performance system user want data to be available in the displays.

Identifying Popular Servers in Server Overview

A good starting point for identifying which servers to monitor in the network is the server overview display. Once an agent has been running for a while it will start reporting network traffic with servers on the network.

The performance system backend automatically registers each server and a counter for the number of times a network report has been received about a specific server is incremented. In the server overview display, the Performance system user will be able to see a list of reported servers ranked by number of network reports. The more highly ranked, the more popular the server is among the agents.

Adding Servers in Server Administration

In the server administration display the Performance system user can identify and single out servers the Performance system user want to monitor. i.e. the Performance system user may add the top 5 servers from the server overview display and/or one or more servers of special interest to the Performance system user. The Performance system user might not be interested in the internet proxy server although it is very popular but instead the Performance system user want to add the print server because people are complaining about long response times when printing.

The Performance system user can add and remove servers from the monitored server list without influence on the statistics collected. The list is only for displaying purposes.

When the Performance system user have moved at least one server from the not monitored list to the monitored list the Performance system user should be able to see the server in the drop down box.

Adding Services

In the preferred embodiment, before the Performance system user can see any network traffic graphs, the Performance system user may need to specify which services to monitor.

This is just for convenience as the number of reported services might be so huge that it is impossible to handle in the graphs section of the display. So the Performance system user need to specify and single out each service for which the Performance system user want data to be available in the displays.

Identifying Popular Services with Service Overview

Once an agent has been running for a while it will start reporting network traffic by different services. The Performance system Backend automatically registers each service and a counter exists for the number of times a network report has been received about a specific service.

By entering the service overview display, the Performance system user will be able to see a list of reported servers ranked by number of network reports. This is a good starting point for identifying which servers to monitor in the network. The more highly ranked, the more popular the server is among the agents.

Adding Services in Service Administration

In the service administration display the Performance system user can identify and single out services the Performance system user want available in the displays. I.e. the Performance system user can add the top 5 services from the service overview display and/or one or more services of special interest to the Performance system user. I.e. the Performance system user might not be interested in the SSH service although it is popular but instead the Performance system user want to add the SAP service because people are complaining about long response times when using SAP.

Grouping Agents

The most important task in maintaining the Performance system configuration is the grouping of agents. This is done in client administration.

In the preferred embodiment grouping is important because the Performance system only keeps data for single agents for less than ˜1 hour. This is for performance and storage reasons. Agent data are aggregated to a group level and agent data older than ˜1 hour is deleted. The Performance system user preferably only keeps data at group level. The more groups the Performance system user create the more data the Performance system user get.

By default preferably all agents become members of the same “Default” group. So by default the Performance system user have one group of agents available containing all the agents.

Why the agents should be grouped.

Response times are measured at the client. The response time is therefore a sum of network transport time to the server, the actual server response time and the network transport time for the first byte of the response to arrive back at the client. This is fine, as we preferably want to know what the actual user experience is.

Users are often placed at different physical locations with varying network bandwidth and latency. If the Performance system user place all agents into the same group the Performance system user will only get a mean response time for all the agents. This might be good for monitoring the server performance because if server performance drops all agents will experience longer response times. But the Performance system user will not get a record of the response times at the different physical locations and therefore the Performance system user do not know what are normal response times for each location.

The Performance system user might get complaints from the users at office location A that the system is slow. The Performance system user have not heard any complaints from office location B. What do the Performance system user do? The Performance system user want to compare the response times of users at office location A with response times at office location B. This can only be done if the Performance system user have grouped agents from office location A into a group called Group A and users from office location B into a group called Group B. This way the Performance system user can find out if both locations are experiencing long response times or it is only at location A. Then the Performance system user know whether this is due to a network/client problem or a backend problem.

As mentioned above it may be a good idea to group agents by physical location. As an agent can be member of more than one group the Performance system user can group by other dimensions too. i.e. the Performance system user can group by user profiles. Accountants use their PC differently than secretaries, system developers and managing directors.

Interpreting Data

Mean Response Time Graphs

The response times showed in the Performance system Display are mean response times. Depending on the given graph the response times are averaged over time, groups, servers or services. Therefore it is important to note if the Performance system user see a peak in a response time graph, the peak level is not the maximum response time experienced by any agent. The experienced peak response time could be several times higher than the mean response time showed as well as the minimum response time experienced by any single agent could be several times smaller than the average number. If the Performance system user choose another combination of groups or servers the Performance system user might very well discover a different response time range.

If the Performance system user increase the resolution of the time graphs (shorter report interval) the averaging effect gets smaller.

When interested in absolute response time values the Performance system user should make sure that the Performance system user are averaging over comparable entities. It is not a good idea to select all services because each service often lies in completely different response time ranges. All services should only be selected to get an overall picture of one particular servers performance over time.

Monitoring a Servers Response Time

By using the Time view of the Performance system Display the Performance system user will be able to follow the response time graph for a single server and service by time. The Performance system user can select the mean response time for all groups of agents. A heavy loaded server usually has increased response times. How loaded the server is the Performance system user may find out by looking at the number of requests/sec send to the server.

Monitoring a Servers Performance Compared to Other Servers

The Server/Service view gives the Performance system user an excellent view of the mean response times for a set of servers and services in a given time period and for a given group. Here the Performance system users will immediate notice if one server is more loaded than the others. E.g. the Performance system user can select all of the SAP-servers, the SAP-service, all groups and the last 24 hours to see how the load has been on the SAP-servers during the day in average for each server.

Comparing performance between groups of agents—identifying network bottlenecks.

The Server/Group view gives the Performance system user an excellent view of the mean response times for a set of servers and groups in a given time period and for a given service. This enables the Performance system user to see if some groups of agents have better response times than others. If the groups of agents are geographically separated there could be a network problem with some of the groups.

Overview of which groups of agents are communicating with which servers

The Server/Group view can give the Performance system user a coupling between servers and groups in a given time period for all services. All response times larger than zero indicate communication between group of agents and server.

The Performance system user can check the response times for the individual agent by entering Client search and identifying the agent of the frustrated user by agent ID, computer name or other. Choose traffic graph and compare the response times from the last half an hour with the group response times. If the response times are larger than for the group there might be something wrong with the network connection of the client or the configuration of the client may be corrupt.

If the response times measured at the client are not worse than for the rest of the agents there could be insufficient resources on the client. In the process list the Performance system user can check whether the end-user at the client has started the client application more than once or whether other applications on his PC are consuming all machine resources.

Basic Entities

Preferably the basic entities in the Performance system are:
Agents
Servers
Services
Groups

The idea is that by looking at network response times for different combinations of servers, services and groups the Performance system user can discover performance problems and bottlenecks in the network and/or backend servers.

Agents

Agents denote PCs on which the Performance system Agent is installed and activated.

Agent ID

An agent receives a unique agent ID from the Performance system Backend when the agent connects to the backend for the first time.

A list of agents each identified by an unique agent ID can be seen in client search of the Performance system Display.

As the computer name, MAC address and especially the IP-address of a PC can change over time, the ONLY unique and constant feature of the agent is the agent ID. A laptop PC is always identified as the same agent although it might change IP-address when an employee disconnects it from the corporate LAN and bring it to his house where it will be used with a dial-up connection.

Agent Data

The data available in the display for an agent corresponds to the set of static and dynamic data about the client PC collected by the agent as described earlier.

Groups

A group may be a set of agents. All agents are preferably member of at least one group.

When installed the Performance system contains one default group called “Default”. All agents registering with the back end will become member of this default group unless given a specific group hint during installation.

The Performance system administrator can create new groups manually.

The importance of grouping agents is discussed in the Grouping agents.

Servers

Servers are defined as the set of machines that has been the server end of one or more TCP/IP connections with one or more agents.

A list of servers can be seen in the administration part of the display. The server list is automatically updated based on the agent network reports.

For each server the IP-address is listed as well as the host name resolution if possible. The Performance system user can rename the server in the display for convenience.

Services

A service is a couple of a TCP/IP server port number and a description.

The TCP/IP port number is preferably in the range from 1 to 65535.

The description is usually the name of the TCP protocol that is normally used with that server port number. i.e. FTP for port 21 and HTTP for port 80.

A list of services can be seen in the administration part of the display. Preferably only services that are predefined or that are reported by the agents are listed.

A TCP port can be used for different purposes in different organizations and therefore the TCP services are often specific for the organizations.

However some services are the same in all organizations. Here is a non exhaustive list of popular TCP services:

| TCP | |
|---|---|
| port | Description |
| 21 | FTP |
| 22 | SSH |
| 23 | TELNET |
| 25 | SMTP |
| 42 | WINS replication |
| 53 | DNS |
| 88 | Kerberos |
| 110 | POP3 |
| 119 | NNTP |
| 135 | RPC |
| 137 | NetBIOS name |
| | service |
| 139 | NetBIOS session |
| | service, SMB |
| 143 | IMAP |
| 389 | LDAP |
| 443 | HTTPS |
| 445 | SMB over IP |
| 515 | Print |
| 636 | LDAP over SSL |
| 1512 | WINS resolution |
| 1521 | Oracle |
| 3268 | Global catalog LDAP |
| 3269 | Global catalog LDAP |
| | over SSL |

Alarms

Alarms are defined as a point in time where the associated baselines alarm-threshold has been exceeded. The alarms may be sampled once every minute, by the back-end database.

Severity

The severity of an alarm is measured as the ratio between samples that fall above the threshold vs. the total number of samples within the time period specified by the baseline.

Status

The status of an alarm is either read or unread.

Example

The Response time graph in FIG. 2 shows data for the server-group ‘Henrik2MedLinux2’ using port-group ‘Henrik’ and agent-group ‘Default’.

It can be seen from the graph in FIG. 2 that the alarm threshold for baseline(linux2) has been exceeded by 56%, in the time interval 12:09-12:12 Dec. 17, 2002.

Configuration

A configuration is a set of parameters used to control the behaviour of an agent.

Performance system comes with a predefined configuration, this configuration is stored in the configuration group named “Default”.

All agents registering with the back end will receive the “Default” configuration.

The Performance system administrator can create new groups manually.

Transaction Filters

In the preferred embodiment, when measuring response times at transaction level, the Performance system user need to specify a mapping from application protocol requests into human readable transaction names for each server and port to monitor.

These mappings are called transaction filters as they actually let the Performance system user filter out specific transactions that the Performance system user want to monitor. A transaction filter definition contains the filter type, the name and port of the servers monitored and the request to transaction name mapping.

Transaction Filter Types

In the preferred embodiment, when creating a transaction filter, the Performance system user need to specify which application protocol the Performance system user are filtering. One available transaction filter type is HTTP for the HyperText Transfer Protocol.

Monitored Servers and Ports

For each server and port combination that the Performance system user want to monitor at the transaction level the Performance system user simply specify the server name and port number.

Simple HTTP Transaction Name Mapping

A simple example of transaction name mapping exists for the HTTP protocol. For instance assume the Performance system user execute the following HTTP request:
GET /index.html HTTP/1.1
Host www.someserver.com

A natural choice of transaction name would be the requested item: “/index.html”.

A demo HTTP transaction filter is included that will create a transaction name for each requested URL on the server.

Custom Report

A custom report is basically a collection of graphs, when used properly a custom report provides the Performance system user with an overview of the service delivered by either a specific application, or a number of applications.

A Performance system administrator creates the report. Graphs are easily added to or removed from existing reports. All the graph types known from the Performance system display can be added to a report.

While creating a report, the administrator also defines a specific URL used to view the report.

The URL is then handed out to the Performance system users that should be able to view the report.

No authentication may be required, the report is protected only by the administrator entered URL. This approach makes it easy to create, maintain and access the report, and still offers a basic protection of possible sensitive data.

The report is preferably HTML based and can be accessed via a standard web browser (IE, Mozilla, Opera etc).

The Performance system Administrator may customize the appearance of the report (Font, Background colour etc.), to give the report a familiar look.

Configuration

Agent Configuration

Agent Registry Keys

The agent uses registry values under a key:

| | |
|---|---|
| Name: | BackendIP |
| Type: | String |
| | Performanceguard |
| Description: | IP address of the machine that runs the |
| | Performance system. |
| Name: | BackEndPort |
| Type: | Dword |
| | 4001 |
| Description: | TCP port that the Performance system collector |
| | accepts connections on. |
| Name: | DeliveryRate |
| Type: | Dword |
| Unit: | Seconds |
| | 180 |
| Description: | This is the time interval between the agent |
| | contact the Performance system collector. |
| Name: | ConnectionTries |
| Type: | Dword |
| Unit: | Seconds |
| | 5 |
| Description: | If the agent has tried to contact the back end this |
| | many times without success it has to throw away |
| | the reports collected so far. This makes sure that |
| | the agent does not deplete memory resources on |
| | the monitored machine. |
| Name: | Id |
| Type: | Dword |
| | 0 |
| Description: | This is the agent identifier. The first time the |
| | agent connects to the Performance system |
| | Collector it gets a new identifier. A backend- |
| | provided id is always larger than zero. |
| Name: | ConfigurationId |
| Type: | Dword |
| | 0 |
| Description: | This is the version number of the configuration. It |
| | is sent to the back end each time reports are |
| | send. |
| Name: | Configuration |
| Type: | String |
| | “# E2E Agent Sample Configuration” |
| Description: | The Configuration contains general parameters |
| | and parameters for the different reports. The |
| | parameters are described in the following section. |
| Name: | MultiClient (This option is not supported for |
| | external use) |
| Type: | Dword |
| | N/A |
| Description: | This parameter controls a special ability of the |
| | agent to emulate multiple agents. It needs to be |
| | added manually to the registry if used. A value |
| | larger than zero enables the feature. |
| | This key is never changed or created by the |
| | agent. |
| Name: | Debug (This option is not supported for external |
| | use) |
| Type: | dword |
| | N/A |
| Description: | If this key is present the agent will try to write |
| | some initialization debug information in a file |
| | called c:\agent.log. |
| | This key is never changed or created by the |
| | agent. |
| Name: | SpoofedClientIP (This option is not supported for |
| | external use) |
| Type: | string |
| | N/A |
| Description: | If this key is present the agent will collect and |
| | process network traffic as if the supplied IP |
| | address was the local address. |
| | This key is preferably never changed or created |
| | by the agent. |
| Name: | Promiscuous (This option is not supported for |
| | external use) |
| Type: | dword |
| | N/A |
| Description: | If this key is present the will place the NIC in |
| | promiscuous mode. |
| | This key is preferably never changed or created |
| | by the agent. |

Agent Command Line Parameters
Windows NT, 2000 and XP

The following command line parameters are used on systems that support services.

In the preferred embodiment, only one option can be used at a time
-install|-installservice|-i

This option is to install the Performance system agent as a service on the machine
-deinstall|-deinstallservice|-uninstall|-uninstallservice|-d|-u

This option is used to remove the service from the machine. If the service has not been installed, it has no effect
-run|-r

Use this option to run the agent directly from the command line
Windows 95, 98 and ME

On Windows operating systems that do not support services there is only a single command line option:
-stop|-s

When the program is invoked with this option all instances of the agent on the machine will be terminated.

Agent Parameters

The following parameters are used to control the behaviour of the agent. They are communicated and stored as a string where the parameters specified each occupies a line and lines are separated by carriage returns or carriage return line feed pairs.

The syntax for a single parameter line is
Internal name=value

The agent stores the current configuration string in the registry in the Configuration key.

The preferred method of creating and changing configurations is using the agent administration part of the Performance system user interface. In the following descriptions Name referrers to the parameter name used in the user interface and Internal Name referrers to the name used when storing and transporting configuration strings.

General Parameters

| | |
|---|---|
| Name: | Report interval in seconds |
| | ReportInterval |
| Unit: | Seconds |
| Default Value: | 60 |
| Description: | This parameter controls the amount of time that |
| | a report line is concerned with. It is not the same |
| | as the delivery interval. |
| Name: | Automatic sending of Network Reports |
| | TCPReport |
| Values: | ‘Enable’ \| ‘Disable’ |
| Default Value: | ‘Enable’ |
| Description: | Enables or disables the Response Time report. |
| Name: | Automatic sending of Process and Dynamic |
| | Machine Reports |
| | DynamicMachineReport |
| Values: | ‘Enable’ \| ‘Disable’ |
| Default Value: | ‘Enable’ |
| Description: | Enables or disables the Dynamic Machine and the |
| | Process reports, i.e. when this parameter is set to |
| | Disable both of the above reports will be disabled. |
| | It is not possible to configure the agent to collect |
| | one of the reports and not the other. |

Basic Report No specific parameters.
Static Machine Report No specific parameters.
Dynamic Machine Report No specific parameters.

Process Report

| | |
|---|---|
| Name: | Sampling interval in seconds |
| | ProcessStatInterval |
| Unit: | Seconds |
| Default Value: | 1 |
| Description: | This is the time that the agent waits between |
| | collecting performance metrics such as CPU and |
| | memory usage. The value controls collection of |
| | metrics for both the machine and individual |
| | processes. |
| Name: | Report % CPU usage higher than |
| | CPUUsageLimit |
| Unit: | % CPU usage |
| Default Value: | 0 |
| Description: | Absolute limit on CPU usage. If the limit is set to |
| | 5%, processes that use 5% or more of the CPU |
| | will be included in the dynamic machine report. |
| | Both the average and the peak CPU usage is |
| | examined, and if either of them exceeds the limit |
| | the process will be included. Usually the limit is |
| | set to 1%, to include only active processes. |
| | If the CPUTop parameter has a value larger than |
| | zero the value of CPUUsageLimit is ignored. |
| Name: | CPU usage top list |
| | CPUTop |
| Unit: | 1 |
| Default Value: | 0 |
| Description: | This parameter is used to select specific |
| | processes for inclusion in the dynamic machine |
| | report. If CPUTop is set to 10, the 10 processes |
| | with the highest average CPU usage will be |
| | selected for inclusion in the report. |
| Name: | Memory usage top list |
| | MemTop |
| Unit: | 1 |
| Default Value: | 0 |
| Description: | This parameter is used to select specific |
| | processes for inclusion in the dynamic machine |
| | report. If MemTop is set to 10, the 10 processes |
| | with the highest average memory usage will be |
| | selected for inclusion in the report. |

Response Time (TCP) Report

| | |
|---|---|
| Name: | Excluded local ports list |
| | IgnoredLocalPorts |
| Unit: | Comma separated list of TCP ports or ‘auto’ |
| Default Value: | 139 |
| Description: | TCP ports specified in this entry are ignored. This |
| | means that all traffic on those ports will be |
| | excluded from the reports. |
| Name: | Automtically discover local server ports |
| | DiscoverServerPorts |
| Values: | ‘true’ \| ‘false’ |
| Default Value: | False |
| Description: | If this is set true the agent will by it self |
| | determine which ports are being used as server |
| | ports locally, and add them to the list of ignored |
| | local ports. The agent will re-examine the tcp |
| | configuration for newly discovered servers at |
| | regular intervals, to take care of servers that |
| | starts listening after the agent has been started. |
| Name: | Enable Promiscuous Mode |
| | Promiscuous |
| Values: | ‘true’ \| ‘false’ |
| Default Value: | False |
| Description: | This entry controls how the network interface |
| | card (NIC) is configured. If it is set to “true” the |
| | agent will try to place the NIC in promiscuous |
| | mode and measure on all packets that pass the |
| | wire that the NIC is connected to. |
| | This release of the agent is not able to correctly |
| | interpret packets that are not intended for or |
| | send by the machine that hosts the agent. |
| Name: | Network Frame Type |
| | FrameType |
| Values: | ‘Ethernet’ \| ‘TokenRing’ |
| Default Value: | Ethernet |
| Description: | This parameter must be set to “TokenRing” if the |
| | computer running the agent is connected to the |
| | network using a token ring network interface |
| | card. Note that the agent only supports token |
| | ring NICs on Windows NT 4.0 |
| Name: | Berkeley Packet Filter Expression |
| | FilterExpression |
| Values: | Berkeley Packet Filter Syntax |
| Default Value: | empty - all packets are examined |
| Description: | This is a Berkeley packet filter expression used by |
| | the agent to filter packets that are used for |
| | response time calculations. See the man-page for |
| | tcpdump for the syntax of Berkeley packet filter |
| | expressions. |
| Name: | Response time histogram in milliseconds |
| | HistogramIntervals |
| Unit: | List of 10 integers, each integer in microseconds |
| Default Value: | 100, 200, 500, 1000, 2000, 5000, 10000, 20000, |
| | 50000, 100000 |
| Description: | This parameter determines the threshold values |
| | for the response time histogram that the agent |
| | uses to classify individual response times. With |
| | the default values the agent will count how many |
| | replies are given within 100 microseconds, how |
| | many are between 100 and 200 microseconds |
| | etc. |

User Interface Parameters

| | GUIMode |
|---|---|
| Values: | See description |
| Default Value: | “Icon Window Exit SendReport” |
| Description: | The value of this parameter is a series of |
| | keywords. Each key word controls a part of the |
| | user interface. The following keywords are |
| | accepted: |

BPF Syntax

The BPF expression selects which packets are analysed by the agent The filter expression is constructed by using the following keywords.

Dir

dir qualifiers specify a particular transfer direction to and/or from id. Possible directions are
src, dst,
src or dst and
src and dst.
   Example ‘src foo’, ‘dst net 128.3’, ‘src or dst port ftp-data’. If there is no dir qualifier, src or dst is assumed.
   proto

proto qualifiers restrict the match to a particular protocol. Possible protos are:

| ether | Fddi | tr | Ip |
|---|---|---|---|
| Ip6 | Arp | rarp | Decent |
| lat | Sca | moprc | mopdl |
| iso | Esis | isis | icmp |
| icmp6 | Tcp | udp | |

E.g., ‘ether src foo’, ‘arp net 128.3’, ‘tcp port 21’.

If there is no proto qualifier, all protocols consistent with the type are assumed. E.g., ‘src foo’ means ‘(ip or arp or rarp) src foo’ (except the latter is not legal syntax), ‘net bar’ means ‘(ip or arp or rarp) net bar’ and ‘port 53’ means ‘(tcp or udp) port 53’.

‘fddi’ is actually an alias for ‘ether’; the parser treats them identically as meaning “the data link level used on the specified network interface.” FDDI headers contain Ethernet-like source and destination addresses, and often contain Ethernet-like packet types, so the Performance system user can filter on these FDDI fields just as with the analogous Ethernet fields. FDDI headers also contain other fields, but the Performance system user cannot name them explicitly in a filter expression.

Similarly, ‘tr’ is an alias for ‘ether’; the previous paragraph's statements about FDDI headers also apply to Token Ring headers.

Primitives

In addition to the above, there are some special ‘primitive’ keywords that do not follow the pattern:gateway, broadcast, less, greater and arithmetic expressions. All of these are described below.

More complex filter expressions are built up by using the words and, or and not to combine primitives. E.g., host foo and not port ftp and not port ftp-data

To save typing, identical qualifier lists can be omitted. E.g., tcp dst port ftp or ftp-data or domain is exactly the same as tcp dst port ftp or tcp dst port ftp-data or tcp dst

True if either the IPv4/v6 source or destination of the packet is host. Any of the above host expressions can be prepended with the keywords, ip, arp, rarp, or ip6 as in:
ip host host
   which is equivalent to:
ether proto \ip and host host

If host is a name with multiple IP addresses, each address will be checked for a match.

ether dst ehost

True if the ethernet destination address is ehost. Ehost may be either a name from /etc/ethers or a number (see ethers(3N) for numeric format).

ether src ehost

True if the ethernet source address is ehost.

ether host ehost

True if either the ethernet source or destination address is ehost.

gateway host

True if the packet used host as a gateway. I.e., the ethernet source or destination address was host but neither the IP source nor the IP destination was host.

dst net net

True if the IPv4/v6 destination address of the packet has a network number of net. Net may be either a name from /etc/networks or a network number.

src net net

True if the IPv4/v6 source address of the packet has a network number of net.

net net

True if either the IPv4/v6 source or destination address of the packet has a network number of net.

dst port port

True if the packet is ip/tcp, ip/udp, ip6/tcp or ip6/udp and has a destination port value of port. The port is a number.

src port port

True if the packet has a source port value of port.

port port

True if either the source or destination port of the packet is port. Any of the above port expressions can be prepended with the keywords, tcp or udp, as in:
tcp src port port
   which matches only tcp packets whose source port is port.
   less length

True if the packet has a length less than or equal to length. This is equivalent to: len<=length.

greater length

True if the packet has a length greater than or equal to length. This is equivalent to: len>=length.

ip proto protocol

True if the packet is an IP packet of protocol type protocol. Protocol can be a number or one of the names icmp, icmp6, igmp, igrp, pim, ah, esp, udp, or tcp. Note that the identifiers tcp, udp, and icmp are also keywords and must be escaped via backslash (\), which is \\ in the C-shell. Note that this primitive does not chase protocol header chain.

ip6 proto protocol

True if the packet is an IPv6 packet of protocol type protocol. Note that this primitive does not chase protocol header chain. May be somewhat slow.
ip protochain protocol. Equivalent to ip6 protochain protocol, but this is for IPv4.
   ether broadcast

True if the packet is an ethernet broadcast packet. The ether keyword is optional.

ip broadcast

True if the packet is an IP broadcast packet. It checks for both the all-zeroes and all-ones broadcast conventions, and looks up the local subnet mask.

ether multicast

True if the packet is an ethernet multicast packet. The ether keyword is optional. This is shorthand for ‘ether[0] & 1 !=0’.

ip multicast

True if the packet is an IP multicast packet.

ip6 multicast

True if the packet is an IPv6 multicast packet.

ether proto protocol

True if the packet is of ether type protocol. Protocol can be a number or one of the names ip, ip6, arp, rarp, atalk, aarp, dec-net, sca, lat, mopdl, moprc, or iso. Note these identifiers are also keywords and must be escaped via backslash (\). [In the case of FDDI (e.g., ‘fddi protocol arp’), the protocol identification comes from the 802.2 Logical Link Control (LLC) header, which is usually layered on top of the FDDI header. The agent assumes, when filtering on the protocol identifier, that all FDDI packets include an LLC header, and that the LLC header is in so-called SNAP format. The same applies to Token Ring.]

lat, moprc, mopdl

Abbreviations for:

ether proto p
where p is one of the above protocols.
   vlan [vlan_id]

True if the packet is an IEEE 802.1Q VLAN packet. If [vlan_id] is specified, only true is the packet has the specified vlan_id. Note that the first vlan keyword encountered in expression changes the decoding offsets for the remainder of expression on the assumption that the packet is a VLAN packet.

tcp, udp, icmp

Abbreviations for:

ip proto p or ip6 proto p
where p is one of the above protocols.
   iso proto protocol

True if the packet is an OSI packet of protocol type protocol. Protocol can be a number or one of the names clnp, esis, or isis.

clnp, esis, isis

Abbreviations for:

iso proto p

where p is one of the above protocols.

expr relop expr

True if the relation holds, where relop is one of >, <, >=, <=, =, !=, and expr is an arithmetic expression composed of integer constants (expressed in standard C syntax), the normal binary operators [+, −, *, /, &, |], a length operator, and special packet data accessors. To access data inside the packet, use the following syntax:
proto [expr: size]

Proto is one of ether, fddi, tr, ip, arp, rarp, tcp, udp, icmp or ip6, and indicates the protocol layer for the index operation.

Note that tcp, udp and other upper-layer protocol types only apply to IPv4, not IPv6. The byte offset, relative to the indicated pro udp index operations. For instance, tcp[0] always means the first byte of the TCP header, and never means the first byte of an intervening fragment.

Combination of primitives

Primitives may be combined using:

A parenthesised group of primitives and operators (parentheses are special to the Shell and must be escaped).
Negation (‘!’ or ‘not’).
Concatenation (‘&&’ or ‘and’).
Alternation (‘∥’ or ‘or’).

Negation has highest precedence. Alternation and concatenation have equal precedence and associate left to right. Note that explicit and tokens, not juxtaposition, are now required for concatenation.

If an identifier is given without a keyword, the most recent keyword is assumed. For example, not host vs and ace is short for not host vs and host ace which should not be confused with not ( host vs or ace )

### EXAMPLES

To process all packets arriving at or departing from sundown:
host sundown

To process traffic between helios and either hot or ace:
host hellos and \( hot or ace \)

To process all IP packets between ace and any host except helios:
ip host ace and not hellos

To process all traffic between local hosts and hosts at Berkeley: host.
tcp[13] & 3 !=0 and not src and dst net localnet

To process IP packets longer than 576 bytes sent through gateway snup:
gateway snup and ip[2:2]>576
   Transaction Filters

In the preferred embodiment, a filter definition contains at least one Host specification, but multiple host specifications are allowed. A filter contains one or more Tag's and each tag contains an id and one or more regular expressions.
HostSpec::=‘Host=‘<ServerName>|<ServerIp>’:’<ServerPort>
   example: Host=http://www.XXXX.dk/
TagSpec::=‘Tag’<TagId>‘=’<TagIdentifier>
TagId::=integer
   example: Tag1.Id=URL:
The tag id may be empty.
RegExpSpec::=‘Tag’<TagId>‘.RegExp’<RegExpId>‘=’
<ExpSource>‘,’<RegularExpression>
ExpSource=‘URL’|‘Method’|<MetaTag>|<Parameter>
RegExpId::=integer
   example: Tag1.RegExp1=URL, {.*}

The regular expression source defines which part of the request should be used when matching the regular expression. If “URL” is specified as the expression source, the regular expression is run on the http uri, excluding any parameters. If “Method” is specified the expression source is the http method, which is always eotehr “GET”or “POST”.

In order to run the regular expression on a http meta-tag the name of the tag needs to be specified, eg. Tag1.RegExp1=Cookie,.*id={.*}. This expression would pull out all text in the cookie meta tag that follows after the text: “id=”.

The regular expressions defines two things: i) the criteria for a match, ii) which part of the regular expression source should be extracted. The part (or parts) that should be extracted are inclosed in curly brackets

Below is an overview of the characters that can be used when specifying regular expressions

| Metacharacter | Meaning |
|---|---|
| . | Match any single character. |
| [ ] | Defines a character class. Matches |
| | any character inside the brackets |
| | (for example, [abc] matches “a”, |
| | “b”, and “c”). |
| \hat{ } | If this metacharacter occurs at the |
| | start of a character class, it negates |
| | the character class. A negated |
| | character class matches any |
| | character except those inside the |
| | brackets (for example, [\hat{ } abc] |
| | matches all characters except “a”, |
| | “b”, and “c”). |
| | If \hat{ } is at the beginning of the |
| | regular expression, it matches the |
| | beginning of the input (for example, |
| | \hat{ } [abc] will only match input that |
| | begins with “a”, “b”, or “c”). |
| − | In a character class, indicates a |
| | range of characters (for example, |
| | [0-9] matches any of the digits “0” |
| | through “9”). |
| ? | Indicates that the preceding |
| | expression is optional: it matches |
| | once or not at all (for example, [0-9] |
| | [0-9]? matches “2” and “12”). |
| + | Indicates that the preceding |
| | expression matches one or more |
| | times (for example, [0-9] + matches |
| | “1”, “13”, “666”, and so on). |
| * | Indicates that the preceding |
| | expression matches zero or more |
| | times. |
| ??, +?, *? | Non-greedy versions of ?, +, and *. |
| | These match as little as possible, |
| | unlike the greedy versions which |
| | match as much as possible. |
| | Example: given the input |
| | “<abc><def>”, <.*?> matches |
| | “<abc>” while <.*> matches |
| | “<abc> <def>”. |
| ( ) | Grouping operator. Example: |
| | (\d+,)*\d+ matches a list of |
| | numbers separated by commas |
| | (such as “1” or “1,23,456”). |
| { } | Indicates a match group. See class |
| | RegexpMatch for a more detailed |
| | explanation. |
| \ | Escape character: interpret the next |
| | character literally (for example, [0-9] + matches |
| | one or more digits, but |
| | [0-9]\+ matches a digit followed by |
| | a plus character). Also used for |
| | abbreviations (such as \a for any |
| | alphanumeric character; see table |
| | below). |
| | If \ is followed by a number n, it |
| | matches the nth match group |
| | (starting from 0). Example: |
| | <{.*?}>.*?</\0> matches |
| | “<head>Contents</head>”. |
| $ | At the end of a regular expression, |
| | this character matches the end of |
| | the input. Example: [0-9]$ matches |
| | a digit at the end of the input. |
| \| | Alternation operator: separates two |
| | expressions, exactly one of which |
| | matches (for example, T\|the |
| | matches “The” or “the”). |
| ! | Negation operator: the expression |
| | following ! does not match the input. |
| | Example: a!b matches “a” not |
| | followed by “b”. |
| \a | Any alphanumeric character. |
| | Shortcut for ([a-zA-Z0-9]) |
| \b | White space (blank). Shortcut for ([ |
| | \t]) |
| \c | Any alphabetic character. Shortcut |
| | for ([a-zA-Z]) |
| \d | Any decimal digit. Shortcut for ([0-9]) |
| \h | Any hexadecimal digit. Shortcut for |
| | ([0-9a-fA-F]) |
| \n | Newline. Shortcut for (\r\|(\r?\n)) |
| \q | A quoted string. Shortcut for |
| | (\″[\hat{ } \″]*\″)\|(\′[\hat{ } \′]*\′) |
| \w | A simple word. Shortcut for ([a-zA- |
| | Z]+) |
| \z | An unsigned integer. Shortcut for |
| | ([0-9]+) |

Tag id Construction

tag id is constructed by concatenating the specified tag id with the information extracted by the regular expressions, e.g.
Tag1.Id=URI:
Tag1.RegExp1=Method, {.*}
Tag1.RegExp2=URL, {.*}
   will return tags like: URI:GET/images/canoo.gif and URI:GET/index.html

Multiple tags and multiple regular expressions

When the Performance system Agent examines a request to determine if it belongs to a filter it will go through the tags in the filter one by one.

For each tag the agent tests if the regular expressions for the tag match.

If all regular expressions match the request matches the tag criteria and the agent constructs a tag id and assigns that tag id to the connection.

If a regular expression for a tag does not match, the agent considers the next tag defined for the filter until a match is found or there are no more tags left to examine.

A connection keeps its tag id until it is closed or a request that generates a different tag id is encountered on the connection. This means that it may be necessary to construct dummy tags in order to de-assign a connection.

Collector Configuration

Collector Command Line Parameters The Performance system collector accepts the following command line parameters:
-install<service name><jvm path><jvm options>-D<collector jar path><control paramters>

The collector is registered as a Windows service using the collector.exe program using the -install parameter.

Control parameters
-start<Java class>-params<argument>
Specifies which java class to call and what argument to give it when the service should start.
-stop<Java class>-params<argument>

Specifies which java class to call and what argument to give it when the service should stop.
-out<filename>

This is the standard output file name for the service.
-err<filename>

This is the standard error file name for the service.
-current<pathname>

Defines the current directory for the service.

Example:
collector.exe-install “PremiTech Performance GUARD Server”% JAVA_HOME %\jre\bin\server\jvm.dll
-Xms256M-Xmx256M-Djava.class.path=collector.jar-start
com.premitech.collector.Server-params start-stop
com.premitech.collector.Server-params stop-out logs\stdout.log-err
logs\stderr.log-current % COLLECTOR_HOME %

Which of cause requires % JAVA_HOME % and % COLLECTOR_HOME % to be set appropriately.

The above service installation is contained in the install_service.bat that is delivered as part of the Performance system back end installation.

Convenience methods

For installation convenience the jar file for the collector i.e. collector.jar also contains methods for installing and uninstalling the collector as a service. Installing the collector this way will use appropriate default parameters.

For a default installation do a:
java-jar collector.jar install

And for a deinstallation:
java-jar collector.jar uninstall

Collector Parameters

The collector accepts all parameters both as command options and as registry settings.

The registry key is:
[HKEY_LOCAL_MACHINE\SOFTWARE\JavaSoft\Prefs\com\premitech\collector]

Which is overruled by:
[HKEY_USERS\.DEFAULT\SOFTWARE\JavaSoft\Prefs\com\premitech\collector]

Which is again overruled by whatever command line parameters are specified.

| | |
|---|---|
| Name: | Admin-port |
| Type: | tcp port |
| | 4002 |
| Description: | The port used to send administrative commands, |
| | like start and stop. |
| Name: | Admin-role |
| Type: | |
| | E2EAdministrator |
| Description: | The name of the administrator user role. |
| Name: | Connection |
| Type: | |
| Description: | This is the name of the database connection to |
| | use. This name is preceding all the parameters |
| | used for the database, i.e. it is possible to have |
| | multiple database set-ups. |
| | Setting this parameter accordingly will change |
| | which one is effective. |
| Name: | <connection>.user |
| Type: | |
| Description: | The Database user name. |
| Name: | <connection>.password |
| Type: | |
| Description: | Password of the database user. |
| Name: | <connection>.url |
| Type: | |
| Description: | Defines a jdbc url used to connect to the |
| | database eg. |
| | jdbc:oracle:thin:@win2000server:1521:win2k |
| Name: | <connection>.maxconn |
| Type: | |
| Description: | Defines the maximum number of connection that |
| | the collector should make to the backend |
| | database. |
| Name: | delivery-interval |
| Type: | |
| Description: | Specifies how often agents connected to the |
| | collector should send updates. |
| Name: | log-configfile |
| Type: | |
| Description: | Specifies where to find the file that defines the |
| | logging levels etc for the collector. |
| | The configfile folloes the java.util.logging format |
| | as described in: |
| | http://java.sun.com/j2se/1.4/docs/api/index.html |
| Name: | mac-id-lookup |
| Type: | boolean |
| | False |
| Description: | Specifies whether the collector should try to look |
| | up the agent's ID from his MAC address when he |
| | reports an ID = 0. If the MAC address was |
| | unknown, he is given a new ID. |
| Name: | max-threads |
| Type: | |
| Description: | The maximum number of threads that the |
| | collector should create in order to service |
| | The Agents. |
| Name: | min-threads |
| Type: | |
| Description: | The maximum number of threads that the |
| | collector should create in order to service the |
| | Agents. |
| Name: | port |
| Type: | |
| Description: | The port where agents should connect and deliver |
| | reports. |
| Name: | socket-timeout |
| Type: | |
| Description: | Specifies in milliseconds, how long the collector |
| | should wait for receiving a complete packet from |
| | the agent before disconnecting. |

Display Configuration

Display configuration parameters:

The following parameters control the behaviour of the Performance system web application. They can be set in either Tomcats server.xml file or the web.xml file belonging to the display web application itself.

Page sizes

These parameters are concerned with the maximum number of rows to display on a page, if the actual number of rows exceeds the parameter value, navigation links are added to the page.

| | |
|---|---|
| Name: | ProtocolPageSize |
| Type: | Intgeger |
| | 200 |
| Description: | Maximum number of Ports to concurrently display |
| | on the port management page size. |
| Name: | ServerPageSize |
| Type: | Integer |
| | 200 |
| Description: | Maximum number of alarms to concurrently |
| | display on the alarm page. |
| Name: | AlarmPageSize |
| Type: | Integer |
| | 200 |
| Description: | Maximum number of servers to concurrently |
| | display on the server management page. |

Chart parameters

These parameters control the caching and refreshing intervals for the generated charts.

| | |
|---|---|
| Name: | Chart.timeout |
| Type: | milliseconds |
| | 5000 |
| Description: | How long to cache the generated charts and |
| | graphs. |
| Name: | chart_cache_size |
| Type: | Number of cache entries |
| | 15 |
| Description: | Size of the performance guards internal chart |
| | cache, each entry in the cache consumes |
| | approximately 200 KB of memory. |
| | If a chart is found in the cache, and the chart is |
| | not timed out (see the Chart.timeout parameters) |
| | then the cached version is returned, this gives a |
| | much better performance for charts that changes |
| | infrequently but is requested often. |
| Name: | Refresh.interval |
| Type: | Seconds |
| | 120 |
| Description: | Time (sec) between the Time View, Server/port |
| | and Server/Group pages refreshes themselves; A |
| | value of 0 disables auto refresh. |

Client activity

Controls, which mark the agent, are given on the Agent Search and Agent management pages.

| | |
|---|---|
| Name: | ClientInactivityMinutesYellow |
| Type: | Minutes |
| | 30 |
| Description: | Minutes of inactivity before the agent's mark |
| | changes from green to yellow. |
| Name: | ClientInactivityMinutesRed |
| Type: | Minutes |
| | 1440 (24 hours) |
| Description: | Minutes of inactivity before the agent's mark |
| | changes from yellow to red. |

Advanced parameters

This section describes the advanced parameters, they can be used to fine-tune and debug the performance system display.

| | |
|---|---|
| Name: | SQL_logFile |
| Type: | Filename |
| | sql_log.txt |
| Description: | File for logging SQL statements execution time, |
| | requires loglevel are at least 4. |
| Name: | jdbc_prefetch_size |
| Type: | integer |
| | 20 |
| Description: | Jdbc row prefetch size, applies to all prepared |
| | statements |
| Name: | sql_folder |
| Type: | folder name |
| | local/ |
| Description: | The SQL statements used in the application are |
| | defined in various files in this folder, this value |
| | should only be changed by a PremiTech |
| | consultant |
| Name: | dns_interval |
| Type: | milliseconds |
| | 60000 |
| Description: | The interval in ms between each time the display |
| | will attempt to resolve server ip-addresses. |
| | A value of 0 (zero) disables the dns job. If the job |
| | is disabled servers can only be identified by their |
| | ip-address, the servers hostname will be |
| | unavailable. |
| Name: | JdbcDriver |
| Type: | jdbc driver class |
| | oracle.jdbc.driver.OracleDriver (Oracle driver) |
| Description: | Jdbc driver for access to the performance system |
| | database |
| | Oracle: |
| | oracle.jdbc.driver.OracleDriver |
| | SQLServer: |
| | com.microsoft.jdbc.sqlserver.SQLServerDriver |
| Name: | JdbcConnectString |
| Type: | |
| | jdbc:oracle:thin:@127.0.0.1:1521:pgrd920p |
| Description: | Database Connection string. |
| | Oracle: |
| | jdbc:oracle:thin:@127.0.0.1:1521:pgrd920p |
| | SQLServer: |
| | jdbc:microsoft:sqlserver://127.0.0.1; SelectMethod = cursor |
| Name: | User |
| Type: | |
| | pguard |
| Description: | Performance system database user name |
| Name: | Password |
| Type: | |
| | pguard |
| Description: | Performance system database password |
| Name: | Connection_pool_size |
| Type: | number of connections |
| | 5 |
| Description: | The number of simultaneous connections to the |
| | performance system database, if an SQL error |
| | occurs on one of the connections in the pool the |
| | application tries to re-establish the connection. |
| Name: | loglevel |
| Type: | integer |
| | 0 |
| Description: | The amount of information to log, legal values are |
| | between 0 and 6. |
| | PremiTech recommends 0 (disable all logging) in |
| | a production environment in order to prevent disc |
| | overflow. |
| Name: | RemoteAdministration |
| Type: | Boolean |
| | True |
| Description: | Is remote administration of client PC' available, if |
| | true then a link is added to the |
| | administration/client search page that allows an |
| | administrator to start a remote administration |
| | session against the selected client. Requires that |
| | the agent is installed with the |
| | nra_Instal option set to Y. |

Display Reference

The Performance System Display is a J2EE web application that can be accessed from any PC through a standard Internet web browser like Internet Explorer or Mozilla. The web application acts as a user-friendly front end to the Performance System Database.

To enter the web application from a browser the Performance system user may need a user ID and a password.

The display preferably consists of two parts: Reports and Administration.

Basic Graphs

Time view settings

The time view graph offers an overview of the response time, sent bytes, received packets etc, the graph is generated based on the parameters selected in the settings field located at the left side of the display screen.

After selecting the graph parameters, click the update button to generate the graph.

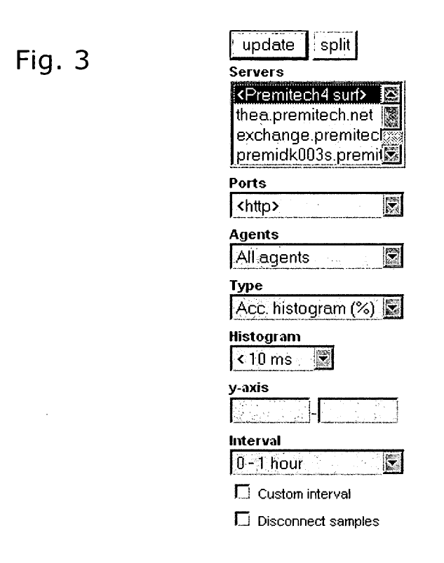

Clicking the split button will split server groups into individual servers, this button is only visible if one or more server groups are selected. The time view setting graph is illustrated in FIG. 3.

Time view graph parameters
Servers: Select which servers and server groups to base the graph on, server groups are enclosed by < >. Only server groups and monitored servers are listed, see server administration for details about monitored ports. Multiple servers and server groups can be selected by pressing the CTRL key while clicking on the servers with the mouse.
Ports: Select which port or port group to base the graph on, port groups are enclosed by < >. Only port groups and monitored ports are listed, see port administration for details about monitored ports.
Groups: Select which group the graph should be based on, defaults to all agents. All means that tcp data from all agents may be included in the graph. The agents mentioned in the following are the agents in the selected group.
Interval: Select which interval the bar chart should be calculated over, default is the last hour. See custom interval for details on how to manually adjust the interval.
Type: Determines which type of data the bar chart will contain, defaults to Response time. The possible selections are described here
y-axis: Enter the y-axis range, if the fields are left empty, or the entered values are invalid, the y-axis range defaults to the minimum and maximum values found in the generated graph.
Disconnect samples: The samples are default connected by a thin line, by checking the Disconnect samples checkbox only the individual dots are displayed on the graph.

Transaction view

Normally data is collected on a tcp packet basis, by defining appropriate filters it is possible to make the agent dig further down into the request and return information about specific elements such as URL'S, cookies etc.

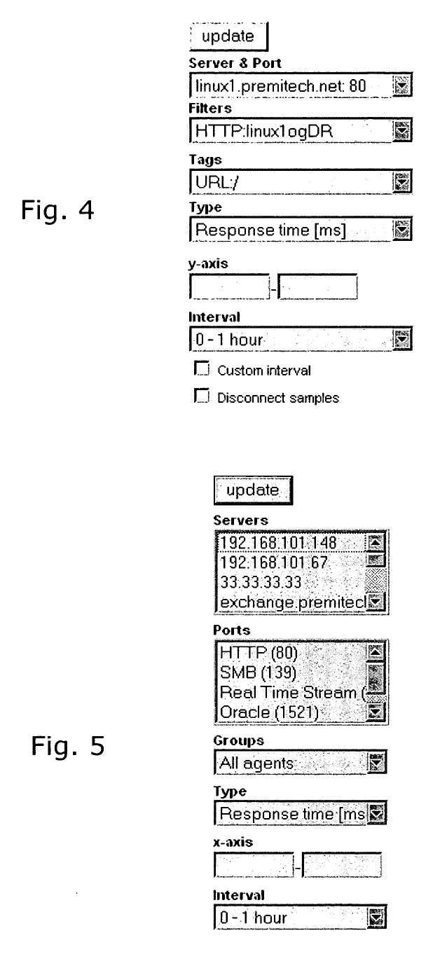

In the preferred embodiment this functionality is available for the HTTP protocol. However the functionality can be extended to other protocols. The tag view graph parameters are illustrated in FIG. 4

Tag view graph parameters
Server & Port: Contains a list of all server and port combinations for which a filter is defined.
Filters: All filters for the selected port and server combination.
Tags: All tags for the selected filter, tags are generated and returned by the agent.
Type: Determines which type of data the graph will contain, defaults to Response time. A description of the possible selections can be found here
   Server/Port settings

The Server/port bar chart displays performance information about an “application's” tcp response time, sent bytes, received bytes etc. for a particular group of agents. (in this context an application is one port on one server, e.g. port 80 (http) on server www.w3.org).

By selecting multiple servers and services, the behaviour for different applications can be compared.

The chart is based on the parameters selected in the settings field located at the left side of the display screen. The server/port setting field is illustrated in FIG. 5.

After selecting the parameters, click the update button to generate the bar chart.

Server/Port bar chart parameters
Servers: Select which servers to include in the chart, if no servers are selected an empty chart is generated. Multiple servers can be selected by pressing the CTRL key while clicking on the required servers with the mouse. Only monitored servers are listed, see server administration for details.
Ports: Select which ports to include in the chart, if no ports are selected an empty chart is generated. Multiple ports can be selected by pressing the CTRL key while clicking on the required ports with the mouse. Only monitored ports are listed, see port administration for details.
Groups: Select which group the bar chart should be based on, defaults to all agents. All means that TCP data from all agents may be included in the bar chart.
Type: Determines which type of data the bar chart will contain, defaults to Response time. The possible selections are described here
x-axis: Enter the x-axis range, if the fields are left empty, or the entered values are invalid, the x-axis range defaults to the minimum and maximum values found in the bar chart.
Interval: Select which interval the bar chart should be calculated over, default is the last hour.
   Server/Agent settings

This bar chart displays the performance on a specific port. Selecting multiple servers and groups makes it possible to compare the average response time delivered to different agent groups from different servers on a particular port.

Each bar displays the ports response time on one server experienced by the clients in one group.

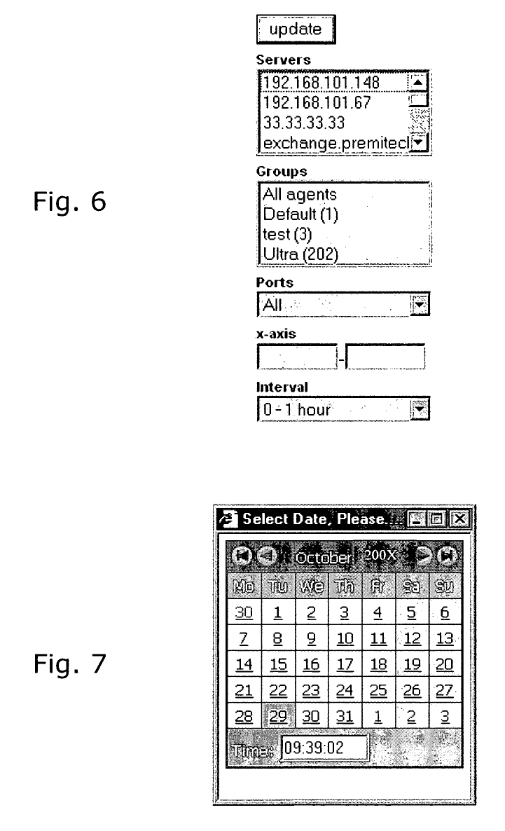

The chart is based on the parameters selected in the settings field located at the left side of the display screen. The Server/Agent setting field is illustrated in FIG. 6.

After selecting the parameters, click the update button to generate the bar chart.

Server/Group bar chart parameters
Servers: Select which servers to include in the chart, if no servers are selected an empty chart is generated. Multiple servers can be selected by pressing the CTRL key while clicking on the servers with the mouse. Only monitored servers are listed.
Groups: Select which groups to include in the chart, if no groups are selected an empty chart is generated. Multiple groups can be selected by pressing the CTRL key while clicking on the group with the mouse.
Ports: Select which port to base the chart on, only monitored ports can be selected.
x-axis: Enter the x-axis range, if the fields are left empty, or the entered values are invalid, the x-axis range defaults to the minimum and maximum values found in the bar chart.
Interval: Select which interval the bar chart should be calculated over, default is the last hour. See custom interval for details on how to manually adjust the interval
   Axis Interval

If the pre-configured interval ranges are too limited, and a more fine grained control is required, it is possible to manually adjust the interval:

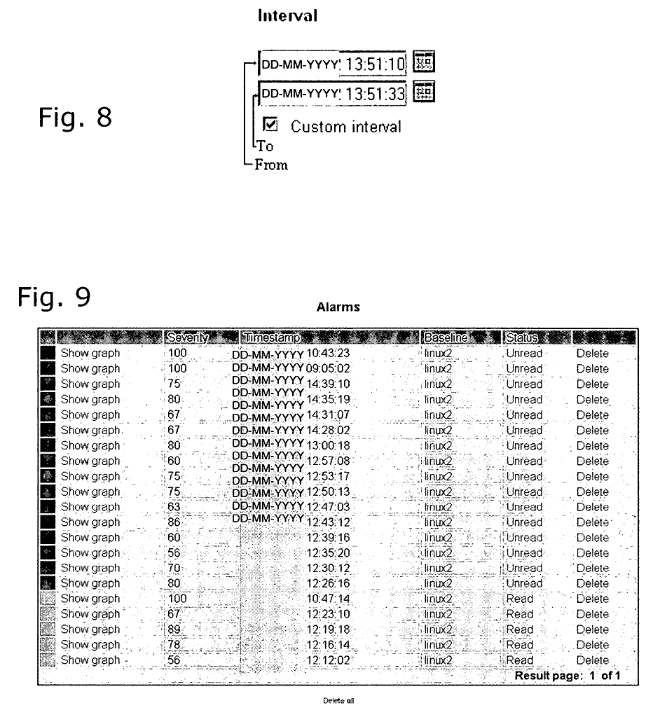

First click the Custom interval checkbox, FIG. 8, to display the from/to edit fields either enter the start/end timestamp or click the calendar image, FIG. 7, to the right of the fields to select the values from a calendar.

Preferably the date format is [DD-MM-YYYY hh:mm:ss].

Alarm Display

The Alarm Display shows a list of detected alarms ordered by their status (read/unread), newness and severity. That is unread alarms precedes read alarms even if their severity is much lower. This is illustrated in FIG. 9.

The left most column in FIG. 9, indicates the status of the alarm by colour: red means unread—yellow means read. Pressing the Status link will change the status. Show graph is a link to the TimeView response time graph showing the selected alarm. Severity, Timestamp and baselines are explained under Basic Entities: Alarms. The last column ‘Delete’ in FIG. 9, deletes the alarm, in the database, on the selected line. The ‘Delete all’ link, at the bottom of the page, will by activation delete all alarms.

Advanced Graphs

Scatter plot

XY scatter plot that shows the response time plotted against the number of requests per second.

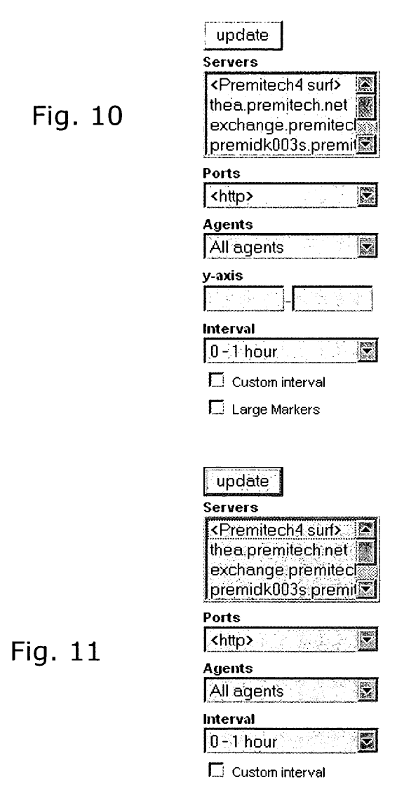

This plot may uncover otherwise hidden scaling problems, if the response time increases to a non acceptable level when the number of requests per second increases it's very likely the result of an overloaded server getting more requests than it can handle. The scatter plot setting interface is illustrated in FIG. 10.

After selecting the parameters, click the update button to generate the plot.

Scatter plot graph parameters
Servers: Select which servers and server groups to base the plot on, server groups are enclosed by < >. Only server groups and monitored servers are listed, see server administration for details about monitored ports. Multiple servers and server groups can be selected by pressing the CTRL key while clicking on the servers with the mouse.
Ports: Select which port or port group to base the plot on, port groups are enclosed by < >. Only port groups and monitored ports are listed, see port administration for details about monitored ports.
Agents: Select which agent group the plot should be based on, defaults to all agents. All means that tcp data from all agents may be included in the plot. The agents mentioned in the following are the agents in the selected group.
Interval: Select which interval the plot should be calculated over, default is the last hour. See custom interval for details on how to manually adjust the interval.
y-axis: Enter the y-axis range, if the fields are left empty, or the entered values are invalid, the y-axis range defaults to the minimum and maximum values found in the generated plot.
Large Markers: The values are plotted as small dots. Check the Large Markers checkbox to draw large markers instead.
   Histogram

This bar chart shows the response time histogram, the histogram consists of 10 individual bars, each bar represents the percentage of replies given within a predefined interval. The predefined intervals [ms] are:
0-100
101-200
201-500
501-1000
1001-2000
2001-5000
5001-10000
10001-20000
20001-50000
50001-

After selecting the parameters, click the update button to generate the histogram. The histogram bar chart setting interface is illustrated in FIG. 11.

Histogram bar chart parameters
Servers: Select which servers and server groups to base the bar chart on, server groups are enclosed by < >. Only server groups and monitored servers are listed, see server administration for details about monitored ports. Multiple servers and server groups can be selected by pressing the CTRL key while clicking on the servers with the mouse.
Ports: Select which port or port group to base the bar chart on, port groups are enclosed by < >. Only port groups and monitored ports are listed, see port administration for details about monitored ports.
Agents: Select which group the bar chart should be based on, defaults to all agents. All means that tcp data from all agents may be included in the graph.
Interval: Select which interval the bar chart should be calculated over, default is the last hour. See custom interval for details on how to manually adjust the interval.

Average distribution

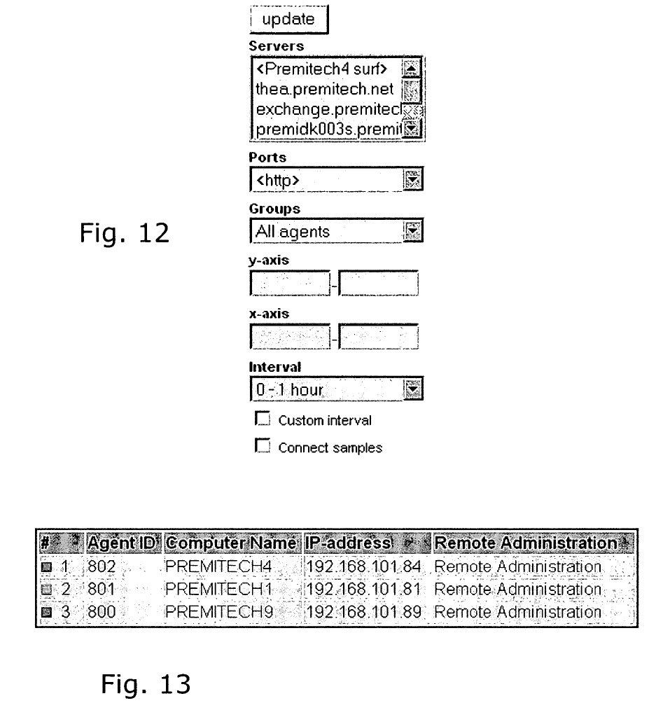

Displays the average response time distribution, the x-axis shows the response time and the y-axis the percentage of the samples with a particular response time. The Average distribution setting interface is illustrated in FIG. 12.

After selecting the graph parameters, click the update button to generate the graph.

Average distribution graph parameters
Servers: Select which servers and server groups to base the graph on, server groups are enclosed by < >. Only server groups and monitored servers are listed, see server administration for details about monitored ports. Multiple servers and server groups can be selected by pressing the CTRL key while clicking on the servers with the mouse.
Ports: Select which port or port group to base the graph on, port groups are enclosed by < >. Only port groups and monitored ports are listed, see port administration for details about monitored ports.
Groups: Select which group the graph should be based on, defaults to all agents. All means that TCP data from all agents may be included in the graph.
Interval: Select which interval the graph should be calculated over, default is the last hour. See custom interval for details on how to manually adjust the interval
y-axis: Enter the y-axis range, if the fields are left empty, or the entered values are invalid, the y-axis range defaults to the minimum and maximum values found in the generated graph.
x-axis: Enter the x-axis range, if the fields are left empty the axis defaults to the minimum and maximum values found in the generated graph.
Connect samples: The graph values are default drawn as single dots, check the Connect samples checkbox to connect them by a thin line.
   Agent Details
   Agent search

On the agent search page it is possible to locate agents that matches a specific search criteria.

The search criteria is made up of the following parameters:
Agent ID: The identifier for the performance system agent installed on the client PC. Leave blank to ignore this parameter.
Computer name: The agent computers network name, the name is case sensitive. Sub strings are allowed (“ECH6” will match “PREMITECH6” as well as “TECH62”, but not “tech62” due to the difference in character case). Leave blank to ignore this parameter.
IP-address: The agent computers IP-address, the match is on a byte basis. Entering “192” “168” “45” “ ” in the four edit fields will return all agents in the 192.168.45.0/24 subnet. (e.g. 192.168.45.1 and 192.168.45.32). Leave the fields blank to ignore this parameter.
Not member of: The agent must not be member of the selected group. Select the entry None to ignore this parameter.
Member of: The agent must be member of the selected group. Select the entry all to ignore this parameter.

Rows: The maximum number of search results that should be displayed per page. If the field is blank, or the entered value is invalid, the value defaults to 10.

Click the lookup button to perform the search, any matches are shown below the search form in a result table illustrated in FIG. 13, on the performance system display screen.

The small image at the leftmost column in FIG. 13 indicates the agents activity level.
Green: The agent delivered one or more reports during the last 30 minutes.
Yellow: The agent delivered one or more reports somewhere between the last 30 minutes and the last 24 hours.
Red: The agent did not deliver any reports during the last 24 hours.

Clicking on the Computer name link will take the Performance system user to the Client info page, if the performance system backend were installed with the remote administration feature enabled then the link Remote Administration will start a remote administration session against the client PC, this requires that the remote administration agent is installed and available on the client PC.

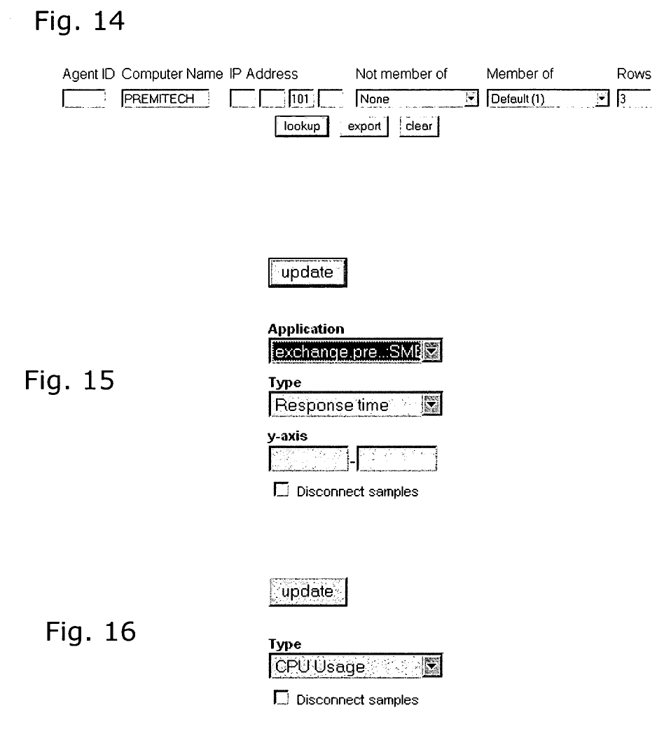

Click the export button, FIG. 14, to return the search result as a csv file (comma separated values).

If installed, Microsoft Excel will open the csv file, otherwise the Performance system user will be prompted to save the file or open it with another program. Export returns more detailed client information than lookup.

Agent Info

The agent info page offers detailed information about a single agent PC.
ID: An integer that uniquely identifies the installed agent.
Agent Name: The name of the installed agent, reserved for future use.
MAC-Address: The network adapters MAC-address.
IP-Address: The agent PC's IP-address.
Computer name: The agent PC's network name.
Delivery interval: The interval between collected data is delivered to the performance system backend.
Configuration Id: The identifier of the agent's configuration.
CPU Type: The type of the installed processor.
Processors: The number of installed processors.
CPU Freq. [MHz]: The CPU's clock frequency in MHz.
OS: The installed operating system, including any service packs.
Total disk size [MB]: The agent PC's total hard disk capacity in MB.
Free disk size [MB]: Amount of free hard disk capacity in MB.
Physical memory [KB]: Installed memory in KB.
Virtual Memory [KB]: Size of the virtual memory pool.
Paging [KB]: The maximum allowed size of the paging file.
IE Version: Internet explorer version.
Network Adapter [Bit/Sec]: The network adapters link speed, if an agent has multiple network adapters then the value is taken from the adapter used to connect to the performance system backend.
Discovered at: Timestamp for the first contact between the agent and the performance system backend.
Refreshed at: Timestamp for the latest contact between the agent and the performance system backend.

Agent traffic graph

The graph displays the response time, received bytes, sent packets etc. from a single agent's point of view during the last 30 minutes. The agent traffic graph setting interface is illustrated in FIG. 15.
Application: Lists the applications that the agent has been in contact with during the last 30 minutes, only applications where both server and port is on the monitored list are displayed. An application is a combination of one server and one port and is displayed as server: port
Type: Determines which type of data the graph will contain, defaults to Response time. A description of the possible selections can be found here
Y-axis: Enter the y-axis range, if the fields are left empty, or the entered values are invalid, the Y-axis range defaults to the minimum and maximum values found in the generated graph.

After adjusting the settings click the update button to generate the graph.

Agent usage graph

This graph displays the last half hours CPU and memory utilization on the agent PC. The agent usage graph setting interface is illustrated in FIG. 16.

Graph type
CPU Usage: The CPU usage in percent
Paging Free: The free space in the paging file.
Physical memory Free: The free physical memory in percent
Virtual Free: The free virtual memory in percent.

After selecting the graph type, click the update button to generate the graph.

Agent process table

The table displays information about the processes running on the selected agent pc, the number of processes in the list depends on the agent configuration
proc. id: The identifier that uniquely identifies a process. The same id can only appear once in the list.
name: The name of the process, the same name can appear multiple times in the list.
cpu peak: The peak cpu usage in percent during the last report interval.
cpu avg.: The average cpu usage in percent during the last report interval.
mem peak: The memory usage peak in KB during the last report interval.
mem avg.: The average memory usage during the last report interval.
thread peak: Maximum number of threads during the last report interval.
thread avg: Average number of threads during the last report interval. Process reports are deleted when they are older than 30 minutes, so if no process reports have been delivered during that period the message “No recent process reports available for agent with id” is displayed instead of the process table.

Agent Group membership

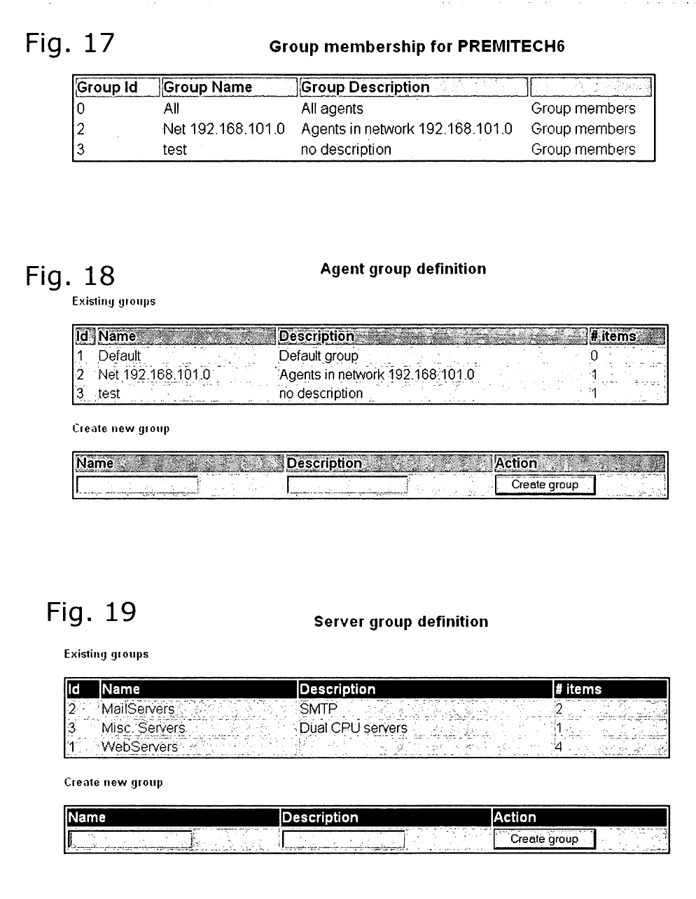

An agent could be member of any number of agent groups. The memberships of an agent are displayed by selecting group members under Agent details. One example is illustrated in FIG. 17, where the agent Premitech6 is a member of three groups

The group members link brings the Performance system user to a page with all group members for the selected group name.

Agent Activity

This table shows the Performance system user an overview of which servers the selected agent has communicated with within the last 30 minutes. The list below contains information on what was going on.
protocol, the port talked to.
hostname, the server talked to.
connections, total number of TCP connections to the sever/port by the agent the last 30 minutes.
resets, total number of TCP connections to the sever/port by the agent the last 30 minutes.
h1-10, defines the number of response measurements in the respective intervals by the agent on the server/port the last 30 minutes.
received_bytes, the total number of bytes received by the agent on the server/port the last 30 minutes.
received_packets, the total number of TCP packets received by the agent on the server/port the last 30 minutes.
received_trains, the total number of trains received by the agent on the server/port the last 30 minutes.
retransmissions, the number of TCP retransmissions by the agent on the server/port the last 30 minutes.
sent_bytes, the number of bytes sent from the agent on the server/port the last 30 minutes.
sent_packets, the total number of TCP packets sent from the agent on the server/port the last 30 minutes.
sent_trains, the total number of requests made by the agent on the server/port the last 30 minutes.
total_response_time, the time until the server/port respond was received by the agent on the server/port the last 30 minutes.
   Group Definition

Definition of groups is basically defining a name and a description for a collection of entities either agents, servers, configuration or ports which is grouped into larger entities. The interface for doing so is approximately the same in all four cases. After defining the group names the Performance system user should enter some members using the appropriate management interface for either agent, server, configuration or ports.

Agent Groups

Existing groups

Shows which groups already exist.
Id: This is the identification for the group.
Name: The name of the group, click the link to navigate to the edit group page.
Description: A supplementary description for the group.
#item: The number of members, selecting this link bring the Performance system user to a page where the group members are listed.

Create new group

Allow the Performance system user to create new groups.
Name: The new name for this group.
Description: A supplementary description for the group.
Action: Press this to create the new group.

FIG. 18 illustrates tables of existing groups and an interface for creating new groups of agents.

Server Groups

Existing groups

Shows which groups already exist.
Id: This is the identification for the group.
Name: The name of the group, click the link to navigate to the edit group page.
Description: A supplementary description for the group.
#item: The number of members, selecting this link bring the Performance system user to a page where the group members are listed.

Create new group

Allow the Performance system user to create new groups.
Name: The new name for this group.
Description: A supplementary description for the group.
Action: Press this to create the new group.

FIG. 19 illustrates tables of existing groups and an interface for creating new groups of servers.

Port Groups

Existing groups

Shows which groups already exist.
Id: This is the identification for the group.
Name: The name of the group, click the link to navigate to the edit group page.
Description: A supplementary description for the group.
#item: The number of members, selecting this link bring the Performance system user to a page where the group members are listed.

Create new group

Allow the Performance system user to create new groups.
Name: The new name for this group.
Description: A supplementary description for the group.
Action: Press this to create the new group.

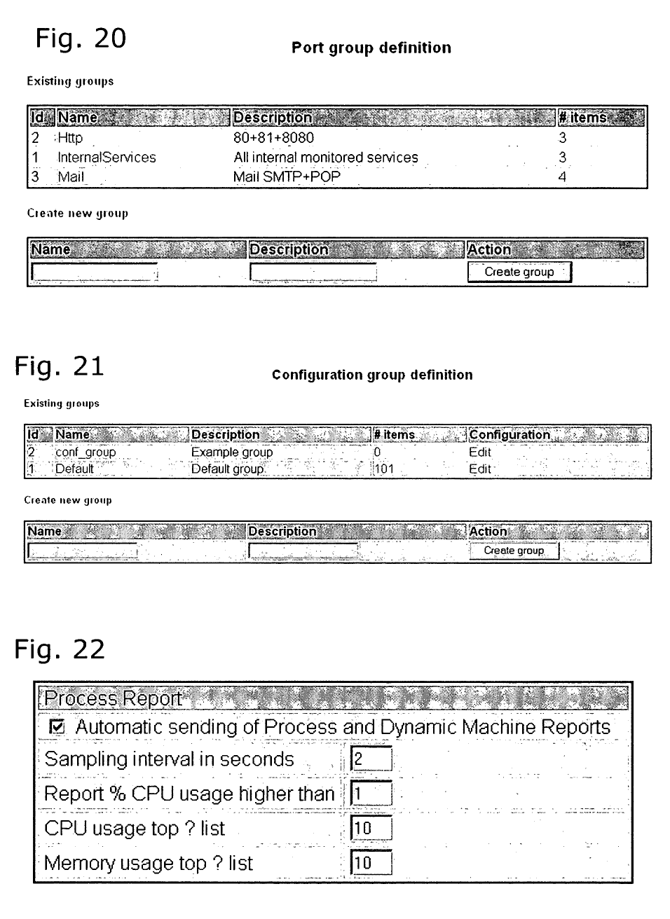

FIG. 20 illustrates tables of existing groups and an interface for creating new groups of ports.

Configuration Groups

Existing groups

Shows which groups already exist.
Id: This is the identification for the group.
Name: The name of the group, click the link to navigate to the edit group page.
Description: A supplementary description for the group.
#items: The number of members, selecting this link bring the Performance system user to a page where the group members are listed.
Configuration, the link in this column will bring the Performance system user to a page where the configuration for the group can be edited.

Create new group

Allow the Performance system user to create new groups.
Name: The new name for this group.
Description: A supplementary description for the group.
Action: Press this to create the new group.

In FIG. 21 is a screen-shot showing a display of each group definition entity.

Configuration Parameters

Agents are grouped together in configuration groups, each configuration group contains exactly one configuration, an agent is member of preferably only one group.

The agent configuration is divided into five main sections:

Process Report
Automatic sending of Process and Dynamic Machine Reports: If enabled, collected reports are automatically send to the performance system backend.
Sampling interval in seconds: The frequency with which the process and system counters are sampled.
Report % CPU usage higher than: Only processes with a higher CPU usage than the specified value will be included in the process data report
CPU usage top: Only the CPU usage top (entered value) processes will be included in the process data report.
Memory usage top: Specifies how many processes sorted by memory allocation to include in the process data report.

The process report interface is illustrated in FIG. 22.

Network Report
Automatic sending of Network Reports: When enabled the network and process data reports will be send automatically.
Berkeley Packet Filter Expression: See BPF syntax for details about Berkeley filters.
Automatically discover local server ports: When enabled the agent will automatically exclude all local ports from the network report.
Excluded local ports list: Comma separated list of local ports that should be excluded from the network report.

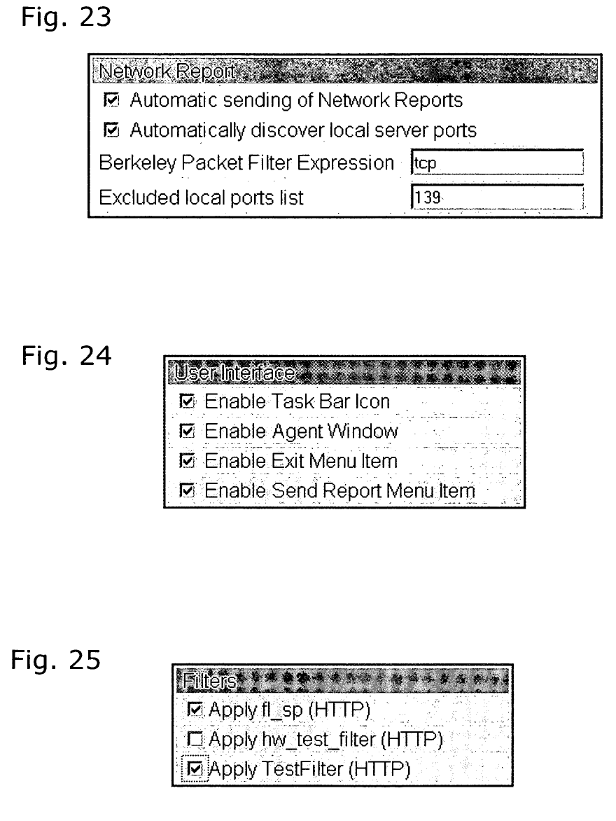

The network report interface is illustrated in FIG. 23.

User Interface

These parameters affect how the agent interacts with the operating system's graphical user interface.

Enable Task Bar Icon: When the agent is running a small icon will be displayed in the task bar area (sometimes also referred to as the system tray).

Enable Agent Window: When enabled, double clicking on the taskbar icon can open the agent's user-interface.
Enable Exit Menu Item: The task bar icon's context menu will contain an “exit” entry when this item is enabled. Clicking the exit menu item will hide the taskbar icon; it will not stop the agent application.
Enable Send Report Menu Item: The task bar icon's context menu will contain a “Send Report” entry if this item is enabled. Clicking the menu item will force the agent to send a report to the performance system backend.

The user interface is illustrated in FIG. 24.

Filters

All checked filters are appended to the configuration, in FIG. 25 the two filters fl_sp and TestFilter are checked.

Filters are defined on the transaction filters page.

General Parameters

These parameters are shared by all agent configuration groups, and thereby all agents.

Report interval: Length of network and process reports.

Response time histogram in milliseconds: These are the 10 comma separated response time intervals. For every network report the agent generates a histogram of response events distributed by response time in the 10 intervals.

Both parameters are read-only, they can only be changed by a PremiTech consultant.

The values can be seen at the Database status page.

Management

Agent Management

With the agent administration interface the performance system administrator can add or remove agents to/from existing groups. The steps needed to locate a specific agent (or a number of agents) are similar to the process described in the agent search section.

Selecting agents

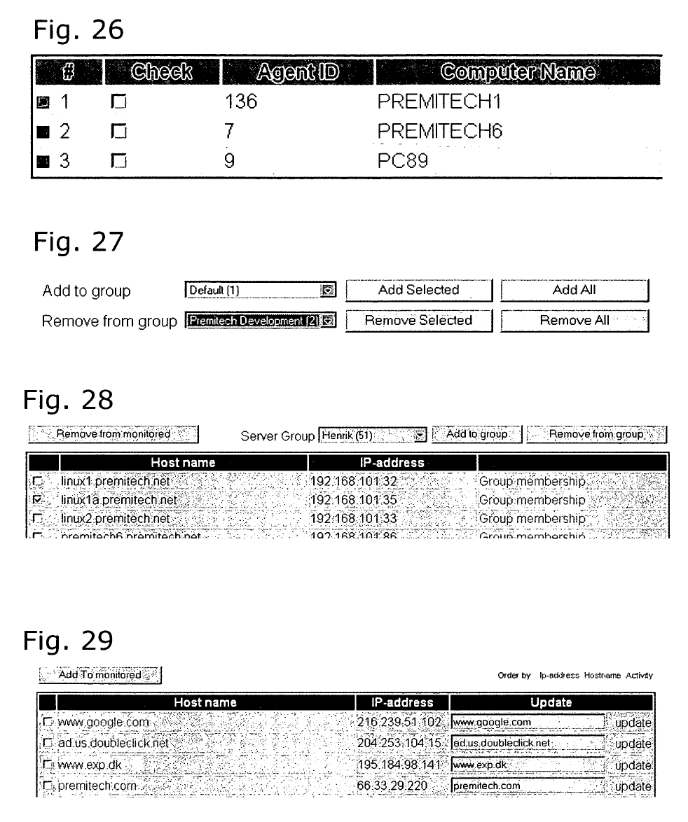

Individual agents in the search result list can be selected by checking the checkbox in the leftmost column in FIG. 26.(in the following referred to as selected agents)

Group management
Add selected: Clicking the Add Selected button will add all selected agents to the selected group in the Add to group drop down box.
Add all: All agents that matched the search criteria will be added to the group selected in the Add to group drop down box when clicking the Add All button. (If the search resulted in multiple pages, then agents that are not yet shown will also be added to the group).
Remove selected: Clicking the Remove Selected button will remove all selected agents from the group in the Remove from group drop down box.
Remove all: Removes all agents that matched the search criteria from the selected group. (If the search resulted in multiple pages, then agents that are not yet shown will also be removed from the group).
   The user interface for the described functions is illustrated in FIG. 27.
   Server Management

The performance system application automatically detects which servers the agent PC's has been in contact with. (Referred to as discovered servers). Agent PC's may be in contact with a large number of servers (potentially thousands) so only a subset of the discovered servers are monitored.

The application will attempt to resolve the IP-addresses (delivered by the agents) to a more readable hostname, if the resolving fails the hostname will be equal to the IP-address.

The administration interface allows the performance system administrator to select which of the discovered servers should be monitored, furthermore the administrator can change the servers resolved hostname (“mailserver” is, for most users, more clear than “jkbh_mail_{—}1242_{—}8173091.net” or some other mysterious auto-generated name).

Monitored servers
Remove from monitored: Remove the selected servers from the monitored list.
Server group: List of all server groups.
Add to group: Add the selected servers to the selected server group.
Remove from group: Remove the selected servers from the selected server group.
Group membership: Click this link to see which server groups the server is member of.

The user interface for the described functions is illustrated in FIG. 28.

Discovered servers
Update hostname: Locate the server in the discovered servers list, enter the new hostname in the update field, and finally click the update link to save the new host name. (see FIG. 11)
Add to monitored: Click the button to add the selected servers to the monitored list.
IP-address: Sort the server list by IP-addresses.
Host-name: Sort the list by hostname.
Activity: Sort the list by server activity, the order is determined by the total number of server hits from all agents.

The user interface for the described functions is illustrated in FIG. 29.

Port Management

Ports contacted by the agent PC's are automatically discovered by the performance system application (discovered ports), and saved in the backend database. The performance system administrator determines which ports to monitor by adding them to the monitored port list.

It is possible to manually add new entries to the discovered port list.

Monitored list
Remove from monitored Remove the selected ports from the monitored list.
Port group: List of all port groups.
Add to group: Add the selected ports to the selected port group.
Remove from group: Remove the selected ports from the selected port group.

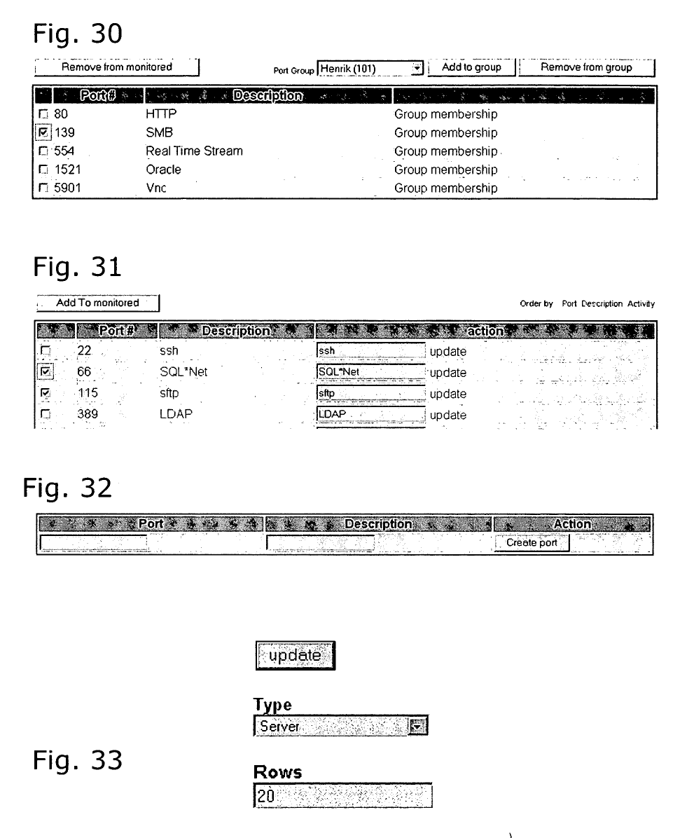

The user interface for the described functions is illustrated in FIG. 30.

Discovered list
Add to monitored: Click the button to add all selected ports to the discovered monitored port list.
Port: Click the link to sort the list based on the port numbers
Description: sort the list by port description
Activity: Sort the list based on the port activity. The more agents that has communicated on a specific port, the higher placement on the list.

The user interface for the described functions is illustrated in FIG. 31.

Creating port

Fill in the port and description fields, then click Create port to add the new port to the discovered list. The entered port number must be unique, two ports can not have the same number even though their descriptions differ.

The user interface for creating a new port is illustrated in FIG. 32.

Miscellaneous

Hit Overview

A horizontal bar chart that displays the hit count for the most accessed servers or ports, the chart is intended as an administration tool to ease the selection of which servers and ports to monitor.

Select the chart type and the number of bars in the settings field, located at the left side of the display screen and illustrated in FIG. 33.

Type: Select server to generate a chart over the most accessed servers, or port to generate a chart over the most accessed ports.
Rows: Enter the number (n) of servers or ports to include in the chart. If the field is left empty, or the entered number is invalid the value defaults to 20.
   When the settings are as wanted, click the update button to generate the bar chart.
      Load Overview

Presents the total load (sent +received bytes) of individual servers or ports in form of a pie chart.

Only servers or ports that together represents 95% of the load are displayed as individual slices, the last 5% are grouped together as a single slice.

Load overview parameters
Servers or Ports: Should the pie chart display servers or ports.
Interval: Select which interval the pie chart should be calculated over, default is the last hour. See custom interval for details on how to manually adjust the interval.
Advanced Mode: Check this to display the Exclude top field.
Exclude top: Exclude the n most loaded servers or ports from the graph.

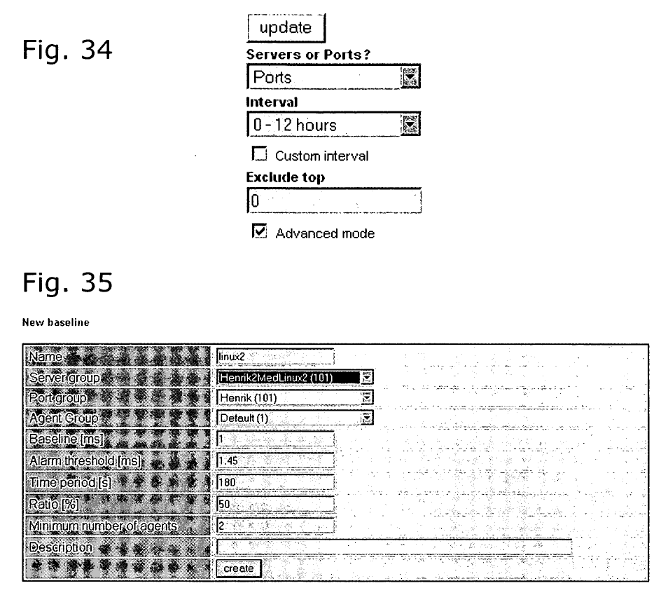

The user interface for the Load overview is illustrated in FIG. 34.

Base Line Administration

Baselines are simply graphical lines that can be drawn on the response time graphs on the Time View page The lines are drawn when the baselines server-, port- and agent- group parameters has exactly the same values as the equivalent parameters selected on the Time View page. The user interface for creating a baseline is illustrated in FIG. 35.
Name: The name for this baseline.
Server group: Select the baseline server group.
Port group: Select the baseline port group.
Agent group: Select the baseline agent group.
Baseline [ms]: Enter the baseline value in milliseconds, which will be drawn as a green line on the response time chart on the Time View page.
Alarm threshold [ms]: Enter the alarm value milliseconds, which will be drawn as a red line on the response time chart on the Time View page.
Time period [s]: Enter the period of time in seconds from which the alarm sampler should use data.
Ratio [%]: Se Basic Entities: Alarms.
Minimum number of agents: The minimum number of agents that shall have delivered data in the time period.
Description: Supplementary text for the alarm.

Response time graph with the baseline created is illustrated in FIG. 36. Note that the selected server, port and groups are identical to the ones created for the baseline.

Activity for a Group of Agents

This table shows the Performance system user an overview of which servers a group of agents has communicated with within a given time interval.

The information includes:
protocol, the port talked to.
hostname, the server talked to.
reports, the total number of times the server/port has been contacted by all agents the last 30 minutes.
connections, total number of TCP connections to the sever/port by all agents the last 30 minutes.
resets, total number of TCP connections to the sever/port by all agents the last 30 minutes.
h1-10, defines the number of response measurements in the respective intervals by all agents on the server/port the last 30 minutes.
received_bytes, the total number of bytes received by all the agents on the server/port the last 30 minutes.
received_packets, the total number of TCP packets recieved by all the agents on the server/port the last 30 minutes.
received_trains, the total number of trains received by all the agents on the server/port the last 30 minutes.
retransmissions, the number of TCP retransmissions by all the agents on the server/port the last 30 minutes.
sent_bytes, the number of bytes sent from all the agents on the server/port the last 30 minutes.
sent_packets, the total number of TCP packets sent from all the agents on the server/port the last 30 minutes.
sent_trains, the total number of requests made by all the agents on the server/port the last 30 minutes.
total_response_time, the time until the server/port respond was received by all the agents on the server/port the last 30 minutes.
   Transaction Filters
   Show filters

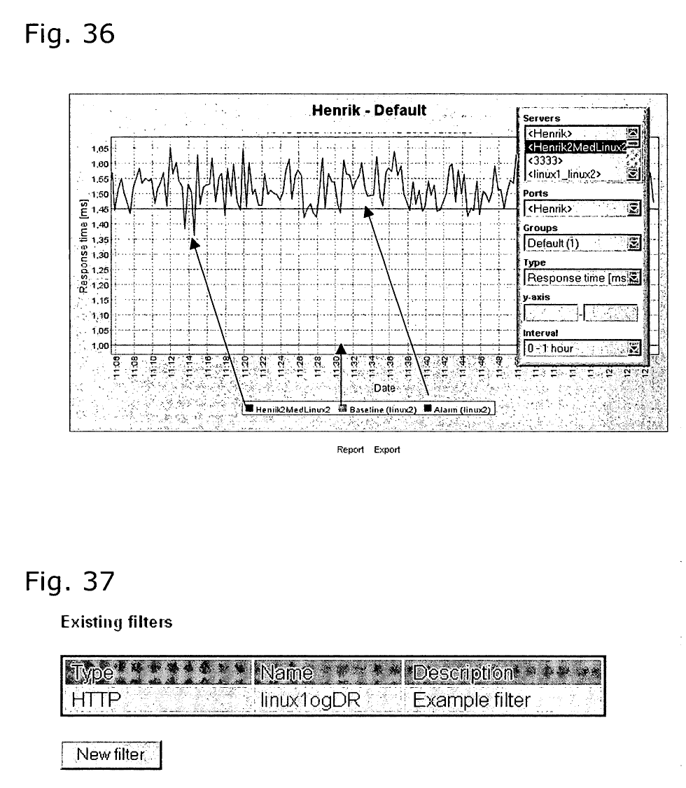

Displays a list of all filters, see filter entity for a description of the Filter entity. The filter can be edited by clicking on the name link, linux1ogDR in the screen shot in FIG. 37, new filters are created by clicking on the New Filter button Create/Edit filter

A filter must have a type, a name and a configuration. A description is not required.

The name is used to identify the filter when creating a transaction view graph, and must be unique, two different filters can not share the same name. Once a filter has been created the name and type can not be modified.

The configuration field contains the filter definition.

A filter definition has a host part and a tag part. The host identifies which hosts (server:port) to consider when filtering requests, the tag part contains the tag identifier and the regular expression used to perform the actual filtering. See section filter entity for a description of the filter entity.

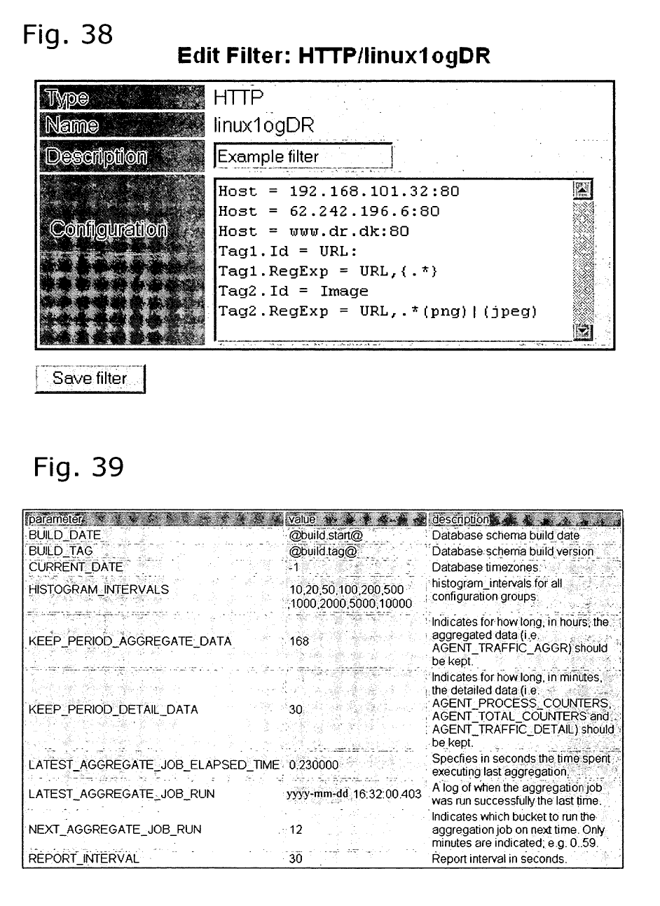

Click the Save filter button illustrated in FIG. 38, to save the filter in the database.

Please note that after changing a filter the Performance system user must visit the configuration page and click save and commit to agents in order to push the new filter definition to the agents.

Database Status

This page gives an overview of the database STATUS-table, illustrated in FIG. 39. The table is read-only from the displays point of view. The Data here is set-up when the system is initially configured.

The description column of the table in FIG. 39 explains the parameter.

User Administration

Two different roles exists, the administrator role has access to all sections of the Performance System display while the pg_user role has limited access. In the preferred embodiment Only one user can be in the administrator role.

User list

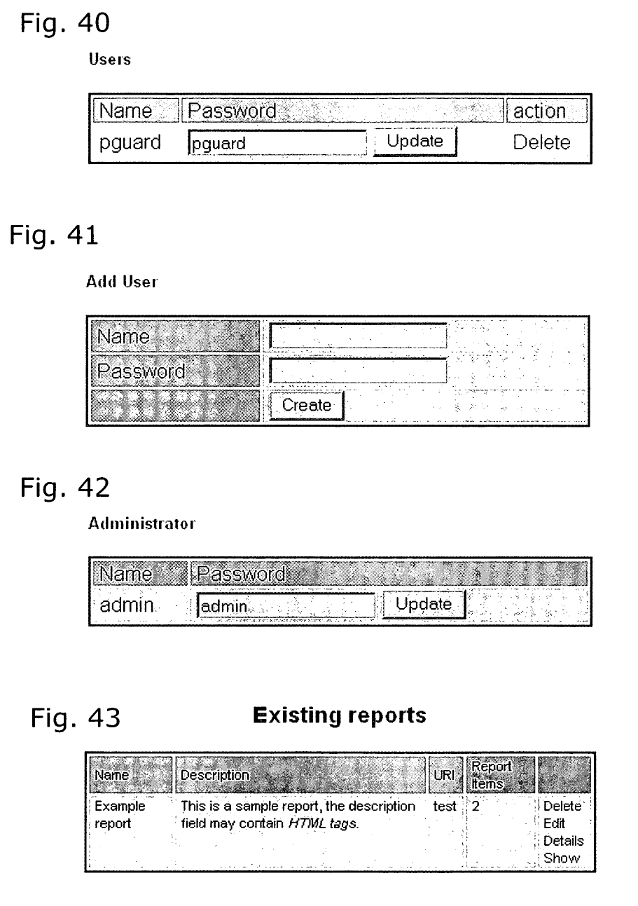

The table lists all the Performance system users in the pg_user role, the administrator is not shown in this list. The user list is illustrated in FIG. 40.

Create User

Create a new user, the Performance system user name must be unique and cannot be blank. The user interface for this function is illustrated in FIG. 41.

Administrator

Change the administrator's password. It is not possible to delete the administrator. The user interface for this function is illustrated in FIG. 42.

Report Management

The Performance System administrator can create, delete and maintain custom reports. There is no limit on the number of reports. One example report is illustrated in FIG. 43.

For performance reasons a report should not contain a large number of different graphs.

Report list
Delete: Deletes the report.
Edit: Change the Report definition.
Details: Show detailed information about the report.
Show: Display the report.

Create/Edit report

Create a new or edit an existing report.
Name: Name of the report as it will be shown on the custom report page.
Description: A description of the report, not required.
Style: The style sheet (CSS) defines how the browser should present the custom report.
URI: The custom reports access point, in this case where the URI is test, and where the Performance System Display is accessible at a specific internet page, then the custom report can be accessed in a directory named “. . . /report/test” on the specific internet page.

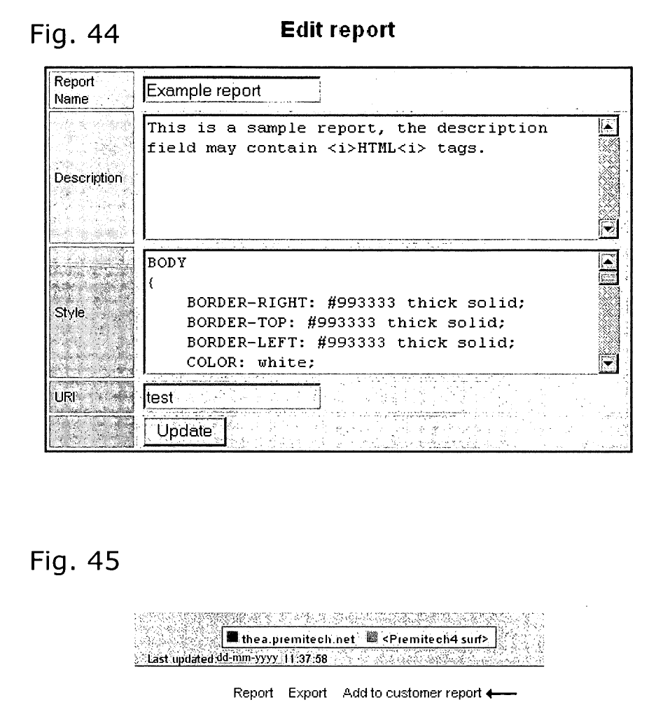

The user interface for this function is illustrated in FIG. 44.

Adding a graph to a report.

When logged in as an administrator all graph pages contains an Add to customer report link, see FIG. 45, clicking on the link will take the Performance system user to the add to report page where the Performance system user attach the graph to a specific report, as well as provides a graph name and description.

Selection Types
Response time: The time until the client received response from the server.
Accumulated histogram (%): Accumulated histogram in percent, when selecting this entry an additional select box with histogram slots is normally displayed.
Requests: The number of requests made by the agent PC.
Active agents: The number of agents that contributed to the graph.
Sent bytes: The number of bytes sent from the agent PC.
Sent packets: The number of tcp packets sent from the agent PC.
Received bytes: The number of bytes received at the agent PC.
Received packets: The number of packets received at the agent PC.
Packets/request: The average number of packets each request consists of.
Bytes/request: The average number of bytes per request.
Reports: The number of clients that made the same type of request.
Connections/sec: Number of connections made per second.
Connection resets (%): Percentage of connection that were reset.
Retransmissions/hour: The number of tcp retransmissions per hour.
Retransmissions (%): Percentage of tcp packets that were retransmitted.

1. A method for measuring and monitoring performance in a computer network environment, the computer network environment being comprised of multiple clients and one or more servers providing one or more services, the method comprising:
monitoring at each client at least a first performance parameter representing the interaction between the client and a server for each true request sent to the server, the performance parameter comprising information about which type of service the request was related to and to which server it was sent;
repetitively collecting data representing the monitored performance parameters from each client at the performance monitor database, and
combining performance parameters for one or more of: requests sent to a specific server, requests related to a specific service type, and requests sent from a specific group of clients;
thereby extracting, from the data monitored at the clients, performance parameters for at least one of: one or more servers; one or more services; and a connection between a server and a client;
whereby the database contains data representative of the at least first performance parameter over time.

2. A method according to claim 1 further comprising monitoring at each client a client performance parameter of the operational system of the client.

3. A method according to claim 1 further comprising the monitoring at each client a performance parameter for the interaction between the client and a server for each true request to a server, the performance parameter being related to the performance of the server in response to true requests from the client.

4. A method according to claim 1, wherein the at least first performance parameter represents a response time of a server upon a request from a client.

5. A method according to claim 1, wherein the collection of data is performed by at least one agent comprised in one or more of the clients.

6. A method according to claim 5, wherein the collection of data is performed passively by the at least one agent.

7. A method according to claim 5, wherein the at least one agent is distributed to each client.

8. A method according to claim 7, wherein the at least one agent is automatically installed.

9. A method according to claim 8, wherein the at least one agent begins collection of data substantially immediately after installation.

10. A method according to claim 4, wherein the response time is the time interval starting when the request, to the server, has been sent from the client until the response from the server arrives at the client.

11. A method according to claim 1, wherein the at least first performance parameter is selected from the set of: CPU usage, memory usage, thread count for a process, handle count for a process, number of transferred bytes, number of made connections, number of transmissions and/or number of package trains send/received.

12. A method according to claim 11, wherein the memory usage comprises free physical memory, virtual memory or a free paging file.

13. A method according to claim 1, wherein the data in the database is organised in data sets so that each set of data represents at least one specific group of clients.

14. A method according to claim 13, wherein the at least one specific group corresponds to at least one of the servers.

15. A method according to claim 1, wherein the data representing the at least first performance parameter is represented by consolidated data, which is accumulated into one or more predetermined performance parameter intervals and stored in the database.

16. A method according to claim 1, wherein the data representing the at least first performance parameter is represented by consolidated data, which is accumulated into one or more predetermined time intervals and stored in the database.

17. A method according to claim 16, wherein the consolidated data represents the performance of a server, in relation to at least one client.

18. A method according to claim 1, wherein the computer network environment comprises at least one administrator device.

19. A method according to claim 1, wherein the clients form a part of a front end system.

20. A method according to claim 19, wherein the front end system comprises at least one administrator device.

21. A method according to claim 1, wherein at least one of the one or more servers form a part of a back end system.

22. A method according to claim 21, wherein the back end system comprises the database.

23. A method according to claim 1, wherein the database comprises a relational database.

24. A method according to claim 1, wherein the data are presented in an administrator display.

25. A method according to claim 24, wherein the administrator display comprises a graphical interface.

26. A method according to claim 24, wherein the administrator display is accessible through any electronic device having a display.

27. A method according to claim 25, wherein the administrator display is accessible through an Internet web browser.

28. A method of performing error detection in a computer network environment, the method comprising using data representative of at least a first performance parameter, the data being provided to a database using a method according to claim 1, for providing information of the at least first performance parameter to an administrator of the computer network environment for error detection/tracing.

29. A method according to claim 28, wherein the error detection is performed on component level.

30. A method according to claim 29, wherein the component comprises CPU, RAM, hard disks, drivers, network devices, storage controllers and storage devices.

31. A method according to claim 1, wherein the computer network is at least partly a wireless network.

32. A method according to claim 1, wherein the computer network is partly a wireless network and partly a wired network.

33. A system for measuring and monitoring performance in a computer network environment, the computer network environment being comprised of comprising multiple clients and one or more servers providing one or more services, the system comprising:
an agent for collecting, during a predetermined period of time, data representative of at least a first performance parameter, said first performance parameter being related to the performance of the one or more servers in response to true requests from at least one client, and
a database for storing the collected data;
wherein the agent repetitively collects data and provide the data to the database, whereby the database contains data representative of the at least first performance parameter over time.

34. A computer program product for measuring and monitoring performance in a computer network environment, the computer network environment being comprised of multiple clients and one or more servers providing one or more services, the computer program product comprising:
monitoring at each client at least a first performance parameter for the interaction between the client and a server for each true request to a server, this performance parameter comprising information of which type of service the request was related to and to which server it was sent,
means for providing a performance monitor database connected to the network,
means for repetitively collecting data representing the monitored performance parameters from each client at the performance monitor database, and
means for combining performance parameters for requests to a specific server and/or requests related to a specific service type; and
at least one of requests from a specific group of clients,
whereby the database contains data representative of the at least first performance parameter over time.

35. A computer-readable data carrier loaded with a computer program product according to claim 34.

36. A computer program product according to claim 34, the computer program product being available for download via the Internet.
